(19) United States
(12) Patent Application Publication
(10) Pub. No.: US 2025/0135350 A1
(43) Pub. Date: May 1, 2025

(54) COMPETITIONS AND PERSONALIZED SOFTWARE CHALLENGES UTILIZING LARGE LANGUAGE MODELS

(71) Applicant: Renormalize Inc., Dover, DE (US)

(72) Inventors: Andrii Gromenko, Abbotsford (CA); Kostiantyn Romanov, Kryhivtsi (UA)

(21) Appl. No.: 18/386,160

(22) Filed: Nov. 1, 2023

(51) Int. Cl. A63F 13/63; G06F 8/20; G06F 40/20

(52) U.S. Cl. CPC A63F 13/63; G06F 8/20; G06F 40/20

(57) ABSTRACT

Methods utilizing Large Language Models (LLMs) in software challenges are presented. A first method focuses on a competitive format between two participants. A user proposes and another user accepts a competition, after which a tailored software challenge, based on their profiles, is created by an LLM. After submission, another LLM evaluates their solutions against the challenge's criteria to determine a winner. A second method revolves around crafting personalized software challenges using LLMs. These challenges are based on various factors, like software ticket details or user characteristics. Accompanied by specific requirements, the challenge is communicated to the user. Upon completion, the solution is assessed for compliance with the set requirements, and successful participants receive an award. Both methods highlight the LLM's capability in automating, personalizing, and evaluating user responses to software challenges.

### TECHNICAL FIELD

A novel system and method for calculating weighted performance metrics across diverse resource categories to enable better understanding and improvement of resource utilization in business operations. A novel system for software development gamification to improve software developer output utilizing weighted performance metrics is also disclosed.

### BACKGROUND INFORMATION

Business and technology are intricately linked sectors in the modern world, with virtually every business depending on technology to some extent. In particular, businesses across a range of sectors rely on various categories of resources to carry out their operations. These resources can include human resources (software development), financial resources, natural resources, and more. Each of these resources contributes to the business in different ways, and the effectiveness of their utilization can greatly impact the overall performance and efficiency of the business.

In traditional business management, evaluating the performance and efficiency of resources often involves manual analysis, using methods such as ROI (Return on Investment) or COGS (Cost of Goods Sold). However, these methods can be time-consuming and may not fully account for the varying importance and impact of different resource categories on the overall performance of the business.

On the technology side, resource management software has been developed to assist businesses in tracking and evaluating their resources. However, many of these systems struggle to handle diversity and complexity in resource types and lack the ability to adequately prioritize and weigh different resource categories according to their impact on the business's objectives.

Thus, there is a need for a more sophisticated system and method for calculating performance metrics across diverse resource categories. Such a system would not only enable businesses to better understand and improve their resource utilization but would also provide insights into how each resource category contributes to the overall business performance. This would be particularly beneficial in complex, multi-resource environments where a more nuanced understanding of resource performance is required.

### SUMMARY

In a first novel aspect, a first method for organizing a software development competition between two participants is disclosed. Initially, one user proposes the competition and another user joins by sending their respective requests. Based on characteristics or profiles of both participants, a unique software development challenge is crafted. This challenge is not just a task but comes with specific requirements or criteria, both of which are tailored using a Large Language Model (LLM). After receiving the challenge, both users submit their code as solutions. Another LLM then steps in to compare the two code listings and checks each solution against the set challenge requirements. Finally, the winner is determined considering three main factors: how the two code listings compare, whether the first user's code aligns with the challenge's criteria, and the same for the second user's code. In summary, this method leverages the capabilities of LLMs to automate and personalize the process of hosting software competitions.

In a second novel aspect, both participants can stake a competition ante, which goes to the winner. The entire process, from challenge creation to winner determination, can be handled by a computing system, and participants interact and receive feedback via a website interface. The evaluating LLM can be one of multiple models, including potential third models not used in challenge creation.

In a third novel aspect, a second method for crafting and overseeing a software development challenge, drawing upon the capabilities of Large Language Models (LLM) is disclosed. The foundation of the challenge can be based on a variety of factors, such as the name or description of a software ticket or specific characteristics of the participating user. Aided by the first LLM, this challenge is meticulously formulated. Beyond the primary challenge, there are accompanying requirements tailored to the user, designed with the assistance of a second LLM. Once ready, the user receives a comprehensive description of both the challenge and its requirements. The system actively observes and identifies when the user has finished the challenge. Subsequently, the user's submitted solution is evaluated to see if it aligns with the outlined requirements. On successful adherence and completion, the user is granted an award, acknowledging their accomplishment and compliance with the challenge's standards.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a diagram illustrating a user dashboard interface.

FIG. 2 is a diagram illustrating a challenge award interface.

FIG. 3 is a diagram illustrating a user performance reporting interface.

FIG. 4 is a diagram illustrating user Key Performance Indicator (KPI) tracing interface.

FIG. 5 is a flowchart diagram illustrating the various steps performed in a user verse user software development challenge methodology.

FIG. 6 is a flowchart diagram illustrating the various steps performed in a personalized user software development challenge methodology.

FIG. 7 is a flowchart diagram illustrating the various steps performed in a data normalization across a plurality of data sources methodology.

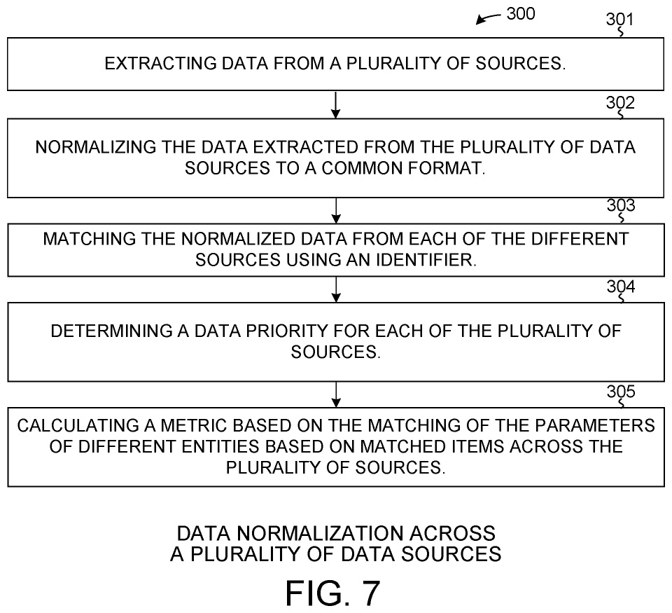

### DETAILED DESCRIPTION

Reference will now be made in detail to background examples and some embodiments of the invention, examples of which are illustrated in the accompanying drawings. In the description and claims below, relational terms such as “top”, “down”, “upper”, “lower”, “top”, “bottom”, “left” and “right” may be used to describe relative orientations between different parts of a structure being described, and it is to be understood that the overall structure being described can actually be oriented in any way in three-dimensional space.

Resource mapping and prioritization includes considering and prioritizing different types of resources when calculating various indicators. The process involves the categorization of resources (Mapping) and determining their relative significance (Ranging) within a category. There are four main types of resources: repositories, issue tracking systems, time tracking systems, and product deployment systems (CI/CD).

Each indicator is calculated using distinct formulas. As a result, the methods for considering different categories of resources and resources within a category (Source) vary. It's crucial to understand that some parameters are calculated based on data from a single category, while others may require data from multiple categories. Therefore, it is essential to correctly correlate values from different categories to calculate such indicators.

We will introduce two concepts to cater to the situations mentioned above: independent sources and dependent sources.

Independent sources: This refers to scenarios where resources can be used independently of each other, and their independent use does not influence the calculation result. An example of this is the number of commits on GitHub, where only one resource category, the Repository, is utilized for the calculation.

Dependent sources: These are scenarios where resources must be used simultaneously, and it affects the calculation result. In such a situation, the values from different resource categories will be employed. An example of this is calculating the time spent on bug fixes, where tasks in issue tracking systems, time tracking systems, and product deployment systems might be involved. This necessitates accurately combining values (Mapping) from multiple tasks/subtasks to determine the time spent on a specific task.

To calculate each indicator, it's necessary to identify which categories of resources will be used and understand their interrelation (Independent/Dependent Categories of Sources). Then, the resources within a category (Sources) need to be identified and their significance determined for the specific indicator (Ranging). The combination of different calculation scenarios will depend on the resource category linkage (Independent/Dependent Categories of Sources), mapping rules for resource categories (Mapping), and the ranking of resource importance (Ranging).

The following indicators will be discussed as examples:
Deployment Frequency
Change Failure Rate
Mean Time To Recovery
Lead Time for Changes
PRs Commented
Linked Data
Unlinked Data
Commits
Average Feedback Score

The calculation algorithm for each indicator should follow these steps:
Define the indicator's purpose
Determine the basic calculation formula
Identify the necessary resource categories
Determine the interrelation between resource categories
Define the rules for mapping resource categories
Determine the importance of resources within each resource category
Update the basic calculation formula accordingly

Below is a brief illustration of the categories of sources for each indicator and the relationships between these sources:

| | User Score | | |
|---|---|---|---|
| Metric | Effect | Customer Sources | Definition |
| Focused Time | Positive | Repository: Github, Gitlab, Bitbucket, Azure | Focused Time is a metric that measures time of |
| | | Issue tracking: Jira, Trello, Asana, Clickup, | focused and intensive work by an individual |
| | | Monday, Teamwork, Github Projects, Gitlab | engineer. Focused and intensive work can be |
| | | Boards | defined as a tracked work on the tasks the are |
| | | Time tracking: Time Doctor, Hubstaff, | related to the main goals of project or tasks with |
| | | Harvest, Google Calendar | the highest priority. So to calculate Focused Time |
| | | | we need to sum up hours spent at those tasks. |
| | | | Also we should exclude inactive hours tracked on |
| | | | timetracking systems. |
| Poor Time | Negative | Repository: Github, Gitlab, Bitbucket, Azure | Poor Time is a metric that measures the time of |
| | | Issue tracking: Jira, Trello, Asana, Clickup, | poor and low activity by an individual engineer. |
| | | Monday, Teamwork, Github Projects, Gitlab | Poor time and low activity can be defined as a work |
| | | Boards | that was done on tasks with low priority, edited time |
| | | Time tracking: Time Doctor, Hubstaff, | in time-tracking systems, tracked time on breaks. |
| | | Harvest, Google Calendar | |
| Working Days | Positive | Repository: Github, Gitlab, Bitbucket, Azure | Working Days is a metric that measures the |
| | | Issue tracking: Jira, Trello, Asana, Clickup, | number of days when some work was done by an |
| | | Monday, Teamwork, Github Projects, Gitlab | individual engineer. Especially we can define |
| | | Boards | Working day as a day when the individual engineer |
| | | Time tracking: Time Doctor, Hubstaff, | tracked at least 8 hours on the defined tasks. |
| | | Harvest, Google Calendar | |
| Meeting Break Time | Positive | Time tracking: Google Calendar | Meeting break time is a metric that measures |
| | | | time spent on other activities between the |
| | | | meetings by an individual engineer. To calculate |
| | | | this metric we |
| | | | should define the time spent on the meeting per |
| | | | one day and the time when the engineer finished |
| | | | his working day. |
| Hours Overtime | Positive | Repository: Github, Gitlab, Bitbucket, Azure | Hours overtime is a metric that measures the |
| | | Issue tracking: Jira, Trello, Asana, Clickup, | excess time spent on work by an individual |
| | | Monday, Teamwork, Github Projects, Gitlab | engineer. Hours overtime can be defined as time |
| | | Boards | was tracked more than normal working day (8 |
| | | Time tracking: Time Doctor, Hubstaff, | hours). |
| | | Harvest, Google Calendar | |
| Code Churn | Positive | Repository: Github, Gitlab, Bitbucket, Azure | Code churn is a metric that measures the |
| | | | percentage of changes made in existing files by an |
| | | | individual engineer over 21-days period. |
| Coding Days | Positive | Repository: Github, Gitlab, Bitbucket, Azure | Coding days is a metric that measures the |
| | | | number of days when the work related to do |
| | | | coding was done by an individual engineer. |
| | | | Coding days can be |
| | | | defined as a days when on work related to coding |
| | | | was tracked at least 8 hours, so to calculate this |
| | | | metric we should detect is there any work on the |
| | | | ticket |
| | | | related to coding, any commits, any pull requests |
| | | | etc. And then we should sum up hours spent on |
| | | | such activities and define number of days spent |
| | | | from hours tracked. |
| Commits | Positive | Repository: Github, Gitlab, Bitbucket, Azure | Commits are individual changes made to a |
| | | | version-controlled code repository. |
| | | | They represent a unit of work that includes adding, |
| | | | modifying, or deleting code files. Each commit |
| | | | typically has a unique identifier and is associated |
| | | | with a commit message that describes the changes |
| | | | made. |
| PR Merged | Positive | Repository: Github, Gitlab, Bitbucket, Azure | PR Merged is a metric that measures the number |
| | | | of prs merged by an engineer. |
| PR Reviewed | Positive | Repository: Github, Gitlab, Bitbucket, Azure | PR Reviewed is a metric that measures the |
| | | | number of prs of this engineer |
| | | | that had been reviewed |
| Large PRs | Negative | Repository: Github, Gitlab, Bitbucket, Azure | Large PRs is a metric that measures number of |
| | | | large prs created by an individual engineer. A pull |
| | | | request that changes more than 500 lines of codes |
| | | | could be considered as “large”. This threshold |
| | | | value could be tuned for a specific engineer, team |
| | | | or organization. |
| Inactive PRs | Negative | Repository: Github, Gitlab, Bitbucket, Azure | Inactive Prs is a metric that measures the number |
| | | | PRs that are inactive for some period of time by |
| | | | an individual engineer. The optimal period of time to |
| | | | consider a pull request as inactive is one week, |
| | | | however, this value could be tuned for a specific |
| | | | engineer, team or organization. |
| Cycled PR Reviews | Negative | Repository: Github, Gitlab, Bitbucket, Azure | Cycled Review PRs is a metric that measures |
| | | | number of prs that went through review more than |
| | | | 3 times by an individual engineer. The number of |
| | | | cycles could be tuned for a specific engineer, team |
| | | | or organization. |
| Overcommented PRs | Negative | Repository: Github, Gitlab, Bitbucket, Azure | Overcommented PRs is a metric that measures |
| | | | number of PRs that have a large amount of |
| | | | comments by an individual engineer. To consider |
| | | | a pull |
| | | | requests as an overcommented one, there should |
| | | | be at least 15 comments per PR. |
| PR Cycle Time | Negative | Repository: Github, Gitlab, Bitbucket, Azure | PR Open is a metric that measures the average |
| | | | time it takes to open a pull request by an individual |
| | | | engineer. |
| | | | PR Review is a metric that measures the average |
| | | | time it takes to review a pull request by an |
| | | | individual engineer. |
| | | | PR Merged is a metric that measures the average |
| | | | time it takes to merge a pull request by an |
| | | | individual engineer. |
| | | | PR Closed is a metric that measures the average |
| | | | time it takes to close a pull request by an individual |
| | | | engineer. |
| Tasks Done | Positive | Issue tracking: Jira, Trello, Asana, Clickup, | Tasks Done (or Tasks Closed) is a metric that |
| | | Monday, Teamwork, Github | measures the number of completed tasks by an |
| | | Projects, Gitlab Boards | individual engineer. |
| Deployment | Positive | Repository: Github, Gitlab, Bitbucket, Azure | Deployment Frequency (DF) is a DORA metric that |
| Frequency | | Ci/CD: Azure Devops, Gihub Actions, Gitlab | measures the frequency of code deployments or |
| | | Cl/CD, Bitbucket Pipelines | releases. It assesses how often software changes |
| | | | are |
| | | | deployed to production, reflecting the |
| | | | organization's ability to deliver updates quickly |
| | | | and consistently. A higher DF value signifies a |
| | | | more frequent and |
| | | | efficient deployment process, indicative of |
| | | | successful DevOps practices and continuous |
| | | | delivery. |
| Lead Time For | Negative | Repository: Github, Gitlab, Bitbucket, Azure | Lead Time for Changes (LT) refers to the elapsed |
| Changes | | Ci/CD: Azure Devops, Gihub Actions, Gitlab | time from the initiation of a change request or task |
| | | Cl/CD, Bitbucket Pipelines | to its completion by an individual engineer. It |
| | | | measures the duration taken by the engineer to |
| | | | implement and deliver the requested changes or |
| | | | updates. LT at the engineer level provides insights |
| | | | into the |
| | | | efficiency and speed of an engineer's workflow and |
| | | | responsiveness to change requests. A shorter LT |
| | | | indicates faster turnaround time in addressing and |
| | | | completing change requests, showcasing the |
| | | | engineer's agility and effectiveness in delivering |
| | | | software changes. |
| Mean Time To | Negative | Repository: Github, Gitlab, Bitbucket, Azure | Mean Time to Recovery (MTTR) refers to the |
| Recovery | | Ci/CD: Azure Devops, Gihub Actions, Gitlab | average duration it takes for an individual |
| | | Cl/CD, Bitbucket Pipelines | engineer to recover from incidents or issues. It |
| | | | measures the time |
| | | | elapsed between the detection or occurrence of an |
| | | | incident and the successful resolution or recovery |
| | | | by the engineer. MTTR at the engineer level |
| | | | provides |
| | | | insights into the efficiency and effectiveness of an |
| | | | engineer's incident response and troubleshooting |
| | | | capabilities. A lower MTTR indicates quicker |
| | | | problem |
| | | | resolution and highlights the engineer's proficiency |
| | | | in addressing and resolving incidents promptly. |
| Changes Failure Rate | Negative | Repository: Github, Gitlab, Bitbucket, Azure | Change Failure Rate (CFR) is a metric that |
| | | Ci/CD: Azure Devops, Gihub Actions, Gitlab | measures the percentage of changes or |
| | | Cl/CD, Bitbucket Pipelines | deployments that result in failures or issues within |
| | | | a given time |
| | | | period. It quantifies the rate at which changes |
| | | | introduce problems or disruptions to the |
| | | | software or system. A higher CFR indicates a |
| | | | higher likelihood of |
| | | | unsuccessful or problematic deployments, |
| | | | highlighting areas that may require |
| | | | improvement in the organization's change |
| | | | management processes or software delivery |
| | | | practices. |
| Positive Impact | Positive | Repository: Github, Gitlab, Bitbucket, Azure | The Positive Impact Indicator measures the |
| | | Issue tracking: Jira, Trello, Asana, Clickup, | extent to which an engineer's contributions have |
| | | Monday, Teamwork, Github Projects, Gitlab | resulted in positive outcomes or improvements |
| | | Boards | within a |
| | | Time tracking: Time Doctor, Hubstaff, | project or team. It assesses the value and |
| | | Harvest, Google Calendar | effectiveness of an engineer's work in driving |
| | | Ci/CD: Azure Devops, Gihub Actions, Gitlab | positive changes. |
| | | Cl/CD, Bitbucket Pipelines | |
| PI Effective Time | Positive | Repository: Github, Gitlab, Bitbucket, Azure | The Positive Impact Effective Time indicator |
| | | Issue tracking: Jira, Trello, Asana, Clickup, | measures the amount of time an engineer |
| | | Monday, Teamwork, Github Projects, Gitlab | spends on tasks or activities that directly |
| | | Boards | contribute to positive |
| | | Time tracking: Time Doctor, Hubstaff, | outcomes and value creation in a project or team. It |
| | | Harvest, Google Calendar | focuses on the productive time spent on tasks that |
| | | Ci/CD: Azure Devops, Gihub Actions, Gitlab | lead to successful code merges, issue resolutions, |
| | | Cl/CD, Bitbucket Pipelines | feature implementations, performance |
| | | | enhancements, or other measurable positive |
| | | | impacts. |
| Positive Impact | Positive | Repository: Github, Gitlab, Bitbucket, Azure | The Positive Impact Division indicator measures |
| Division | | Issue tracking: Jira, Trello, Asana, Clickup, | the distribution of positive impacts achieved by an |
| | | Monday, Teamwork, Github Projects, Gitlab | engineer across different areas, including Code, |
| | | Boards | Tasks, Deploy, and Time. It provides insights into |
| | | Time tracking: Time Doctor, Hubstaff, | how an engineer's efforts contribute to positive |
| | | Harvest, Google Calendar | outcomes in these specific domains. |
| | | Ci/CD: Azure Devops, Gihub Actions, Gitlab | Code: This part of the indicator focuses on the |
| | | Cl/CD, Bitbucket Pipelines | engineer's impact on code quality and functionality, |
| | | | such as the number of successful code merges, |
| | | | code improvements, or bug fixes. |
| | | | Tasks: This part assesses the engineer's impact on |
| | | | task completion and resolution, including the |
| | | | number of tasks completed, tasks closed, or issues |
| | | | resolved. |
| | | | Deploy: This part evaluates the engineer's impact |
| | | | on deployment activities, such as successful |
| | | | deployments, production releases, or |
| | | | implementation of new features. |
| | | | Time: This part considers the engineer's impact in |
| | | | terms of time management and efficiency, such as |
| | | | meeting deadlines, minimizing delays, or optimizing |
| | | | work processes. |
| | | | By analyzing the Positive Impact Division indicator, |
| | | | you can gain a holistic view of an engineer's |
| | | | contributions across these different areas, |
| | | | identifying |
| | | | strengths, areas for improvement, and patterns of |
| | | | impact distribution. This |
| | | | information can help drive targeted efforts for skill |
| | | | development, process |
| | | | optimization, and resource allocation to maximize |
| | | | positive outcomes in software development |
| | | | projects. |
| Efficiency | Positive | Repository: Github, Gitlab, Bitbucket, Azure | The Efficiency Indicator measures the |
| | | Issue tracking: Jira, Trello, Asana, Clickup, | effectiveness and productivity of engineer's work. |
| | | Monday, Teamwork, Github Projects, Gitlab | It takes into account various factors such as the |
| | | Boards | number of tasks completed, the time taken to |
| | | Time tracking: Time Doctor, Hubstaff, | complete tasks, the code quality, and the |
| | | Harvest, Google Calendar | successful delivery of features or enhancements. |
| | | Ci/CD: Azure Devops, Gihub Actions, Gitlab | The Efficiency Indicator |
| | | Cl/CD, Bitbucket Pipelines | provides engineers with insights into their |
| | | | performance, efficiency, and ability to |
| | | | deliver high-quality work within a given timeframe. |
| | | | It serves as a valuable tool for self-assessment, |
| | | | identifying areas for improvement, and optimizing |
| | | | their workflow to achieve higher levels of efficiency |
| | | | and productivity. |
| Tasks Ratio | Negative | Issue tracking: Jira, Trello, Asana, Clickup, | Tasks ratio (late/in time) is an indicator that |
| (Late/In Time) | | Monday, Teamwork, Github Projects, Gitlab | measures the proportion of tasks completed late |
| | | Boards | versus tasks completed on time by an engineer. It |
| | | Time tracking: Time Doctor, Hubstaff, | provides insights into the engineer's ability to meet |
| | | Harvest, Google Calendar | task deadlines effectively. |
| PR Ratio | Negative | Repository: Github, Gitlab, Bitbucket, Azure | PR ratio (Rejected/Total) is an indicator that |
| (Rejected/Total) | | Time tracking: Time Doctor, Hubstaff, | measures the proportion of pull requests rejected |
| | | Harvest, Google Calendar | compared to the total number of pull requests |
| | | | created by an engineer. It provides insights into the |
| | | | engineer's success rate in having their pull |
| | | | requests accepted and merged into the codebase. |
| Jobs Ratio | Positive | Time tracking: Time Doctor, Hubstaff, | The Jobs ratio (Succeed/Failed) is an indicator |
| (Succeeded/Failed) | | Harvest, Google Calendar Ci/CD: Azure | that measures the ratio of successful |
| | | Devops, Gihub Actions, Gitlab Cl/CD, | deployments to failed deployments for an |
| | | Bitbucket Pipelines | engineer. It provides |
| | | | insights into the engineer's ability to successfully |
| | | | deploy changes or updates to a production |
| | | | environment. |
| Velocity | Negative | Issue tracking: Jira, Trello, Asana, Clickup, | Velocity is an indicator that measures the rate at |
| | | Monday, Teamwork, Github | which an engineer is completing work in terms of |
| | | Projects, Gitlab Boards | story points (SP). It provides insights into the |
| | | | productivity and efficiency of the engineer or team |
| | | | in delivering work over a specific time period. |
| | | | Velocity is calculated by summing up the story |
| | | | points associated with the tasks or user stories |
| | | | completed during the specified time period. It |
| | | | reflects the |
| | | | engineer's capacity to deliver value and can help |
| | | | with forecasting and planning future work. |
| Tech Debt | Negative | Repository: Github, Gitlab, Bitbucket, Azure | Tech Debt is an indicator that shows current weak |
| | | | points of the code that engineer/team is working on |
| | | | that needs to be refactored |
| Following Best | Positive | Repository: Github, Gitlab, Bitbucket, Azure | FBP is an indicator that shows how often an |
| Practice | | | engineer uses best practices in his work. It shows |
| | | | what part of the whole code produced following |
| | | | best practices in %. |
| Avg Server Downtime | Negative | Ci/CD: Azure Devops, Gihub Actions, Gitlab | Average Server Downtime is an indicator that |
| | | Cl/CD, Bitbucket Pipelines | measures the average amount of time that a server |
| | | | is not accessible. |
| Outdated | Negative | Repository: Github, Gitlab, Bitbucket, Azure | Outdated Dependencies is an indicator that |
| Dependencies | | | measures the number of software dependencies |
| | | | that are not up-to-date with their latest versions. |
| Average Server Load | Negative | Infrastructure: AWS | Average Server Load is an indicator that measures |
| | | | the average demand on a server's resources (CPU |
| | | | usage, memory) over a specific period of time. |
| Average Database | Negative | Infrastructure: AWS | Average Database Load is an indicator that |
| Load | | | measures the average demand on a database's |
| (Requests/Minute) | | | resources (requests per minute). |
| Bugs Detected | Negative | Repository: Github, Gitlab, Bitbucket, Azure | Bugs Detected (BD) is a metric that measures the |
| | | Issue tracking: Jira, Trello, Asana, Clickup, | number of bugs detected by the same engineer. |
| | | Monday, Teamwork, Github Projects, Gitlab | |
| | | Boards | |
| | | Time tracking: Time Doctor, Hubstaff, | |
| | | Harvest, Google Calendar | |
| Bugs Resolved | Positive | Repository: Github, Gitlab, Bitbucket, Azure | Bugs resolved (BR) is a metric that measures the |
| | | Issue tracking: Jira, Trello, Asana, Clickup, | number of bugs fixed by one engineer, even if they |
| | | Monday, Teamwork, Github Projects, Gitlab | were not created by him/her. |
| | | Boards | |
| | | Time tracking: Time Doctor, Hubstaff, | |
| | | Harvest, Google Calendar | |
| Bug Cycle Time: | Negative | Repository: Github, Gitlab, Bitbucket, Azure | Bug Detected Time is a metric that measures an |
| Detected | | Issue tracking: Jira, Trello, Asana, Clickup, | average time it takes to detect a bug by an |
| | | Monday, Teamwork, Github Projects, Gitlab | individual engineer. |
| | | Boards | |
| | | Time tracking: Time Doctor, Hubstaff, | |
| | | Harvest, Google Calendar | |
| Bug Cycle Time: Fixed | Negative | Repository: Github, Gitlab, Bitbucket, Azure | Bug Fixed Time is a metric that measures an |
| | | Issue tracking: Jira, Trello, Asana, Clickup, | average time it takes to fix the bug by an engineer, |
| | | Monday, Teamwork, Github Projects, Gitlab | starting from detecting this bug. |
| | | Boards | |
| | | Time tracking: Time Doctor, Hubstaff, | |
| | | Harvest, Google Calendar | |
| Bug Cycle Time: | Negative | Repository: Github, Gitlab, Bitbucket, Azure | Bug Tested Time is a metric that measures an |
| Tested | | Issue tracking: Jira, Trello, Asana, Clickup, | average time it takes to test fixed bug by an |
| | | Monday, Teamwork, Github Projects, Gitlab | individual engineer. |
| | | Boards | |
| | | Time tracking: Time Doctor, Hubstaff, | |
| | | Harvest, Google Calendar | |
| Bug Cycle Time: | Negative | Repository: Github, Gitlab, Bitbucket, Azure | Bug Closed Time is a metric that measures an |
| Closed | | Issue tracking: Jira, Trello, Asana, Clickup, | average time it takes to detect, fix, test and close a |
| | | Monday, Teamwork, Github Projects, Gitlab | bug by an individual engineer. |
| | | Boards | |
| | | Time tracking: Time Doctor, Hubstaff, | |
| | | Harvest, Google Calendar | |
| Tasks Late | Negative | Issue tracking: Jira, Trello, Asana, Clickup, | Tasks Late (TL) is a metric that measures the |
| | | Monday, Teamwork, Github Projects, Gitlab | number tasks completed later than estimated |
| | | Boards | deadline by an individual engineer. |
| | | Time tracking: Time Doctor, Hubstaff, | |
| | | Harvest, Google Calendar | |
| Tasks In Time | Positive | Issue tracking: Jira, Trello, Asana, Clickup, | Tasks In Time (TIT) is a metric that measures the |
| | | Monday, Teamwork, Github Projects, Gitlab | number of tasks completed earlier than estimated |
| | | Boards | deadline by an individual engineer. |
| | | Time tracking: Time Doctor, Hubstaff, | |
| | | Harvest, Google Calendar | |
| PRs Commented | Positive | Repository: Github, Gitlab, Bitbucket, Azure | The PR Commented Indicator refers to the count |
| | | | or number of pull requests on which an |
| | | | individual has provided comments. It represents |
| | | | the level of |
| | | | engagement and involvement of the person in |
| | | | reviewing and offering feedback |
| | | | on pull requests. Higher values indicate active |
| | | | involvement and a willingness to |
| | | | provide valuable feedback and insights to improve |
| | | | the quality of the codebase. |
| | | | It also signifies the individual's contribution to |
| | | | promoting best practices, identifying issues or |
| | | | bugs, and sharing knowledge with the team. |
| Tasks Commented | Positive | Issue tracking: Jira, Trello, Asana, Clickup, | The Tasks Commented Indicator measures the |
| | | Monday, Teamwork, Github | level of engagement an engineer has in providing |
| | | Projects, Gitlab Boards | comments on tasks within a project or workflow |
| | | | management system. It tracks the number of tasks |
| | | | on which the engineer has |
| | | | left comments, indicating their involvement in |
| | | | discussing, providing feedback, or seeking |
| | | | clarification on specific tasks. |
| Time To Reply (task) | Negative | Issue tracking: Jira, Trello, Asana, Clickup, | The Time To Reply (Task) Indicator measures the |
| | | Monday, Teamwork, Github | average time taken by an engineer to respond |
| | | Projects, Gitlab Boards | or provide a reply to a task. It helps assess the |
| | | | responsiveness and efficiency of an engineer in |
| | | | addressing tasks assigned to them. |
| Time To Reply (PRs) | Negative | Repository: Github, Gitlab, Bitbucket, Azure | The Time To Reply (PR) Indicator measures the |
| | | | duration it takes for an engineer to respond to a |
| | | | pull request. It represents the time elapsed |
| | | | between the moment a pull request is created or |
| | | | submitted for review and the moment the engineer |
| | | | provides a response or comment on the pull |
| | | | request. |
| Reaction Time (task) | Negative | Issue tracking: Jira, Trello, Asana, Clickup, | The Reaction Time (Task) indicator measures the |
| | | Monday, Teamwork, Github | average time it takes for an engineer to react or |
| | | Projects, Gitlab Boards | take initial action upon receiving a task or request. |
| | | | It provides insights into the promptness and agility |
| | | | of an engineer in acknowledging and initiating work |
| | | | on assigned tasks. |
| Reaction Time (PRs) | Negative | Repository: Github, Gitlab, Bitbucket, Azure | The Reaction Time (PR) Indicator measures the |
| | | | time it takes for an engineer to react or respond |
| | | | to a pull request. It represents the duration |
| | | | between the |
| | | | moment a pull request is created or submitted for |
| | | | review and the moment the |
| | | | engineer takes some action in response to the pull |
| | | | request, such as leaving a comment, approving the |
| | | | pull request, or making changes to the code. |
| Involvement | Positive | Repository: Github, Gitlab, Bitbucket, Azure | The Involvement Indicator measures the level of |
| | | Issue tracking: Jira, Trello, Asana, Clickup, | an engineer's active participation and engagement |
| | | Monday, Teamwork, Github Projects, Gitlab | in a project or team. It reflects the extent to which |
| | | Boards | the engineer is involved in various activities, such |
| | | Time tracking: Time Doctor, Hubstaff, | as code reviews, discussions, task assignments, |
| | | Harvest, Google Calendar | and overall collaboration within the development |
| | | Ci/CD: Azure Devops, Gihub Actions, Gitlab | process. |
| | | Cl/CD, Bitbucket Pipelines | The indicator takes into account different aspects |
| | | | of involvement, including the number of pull |
| | | | requests commented on, tasks assigned or |
| | | | worked on, code |
| | | | contributions made, participation in discussions or |
| | | | meetings, and engagement with team members. |
| Influence | Positive | Repository: Github, Gitlab, Bitbucket, Azure | The Influence Indicator refers to an engineer's |
| | | Issue tracking: Jira, Trello, Asana, Clickup, | ability to have an impact on the decisions, |
| | | Monday, Teamwork, Github Projects, Gitlab | outcomes, and direction of a project or team. It |
| | | Boards | assesses the extent to which an engineer's work |
| | | Time tracking: Time Doctor, Hubstaff, | and contributions influence and shape the overall |
| | | Harvest, Google Calendar | project's success. A higher influence score |
| | | Ci/CD: Azure Devops, Gihub Actions, Gitlab | indicates a greater ability to drive positive change |
| | | Cl/CD, Bitbucket Pipelines | and make meaningful contributions. |
| Linked data | Positive | Repository: Github, Gitlab, Bitbucket, Azure | Linked data are pieces of data that are explicitly |
| | | Issue tracking: Jira, Trello, Asana, Clickup, | associated with specific commits, PRs, tasks, |
| | | Monday, Teamwork, Github Projects, Gitlab | issues, or tickets, pipelines, time tracking tasks |
| | | Boards | within a |
| | | Time tracking: Time Doctor, Hubstaff, | source control management platform. They |
| | | Harvest, Google Calendar | represent changes directly related |
| | | Ci/CD: Azure Devops, Gihub Actions, Gitlab | to the work items |
| | | Cl/CD, Bitbucket Pipelines | |
| Unlinked data | Negative | Repository: Github, Gitlab, Bitbucket, Azure | Unlinked data are pieces of data that are not |
| | | Issue tracking: Jira, Trello, Asana, Clickup, | explicitly associated with specific commits, PRs, |
| | | Monday, Teamwork, Github Projects, Gitlab | tasks, issues, or tickets, pipelines, time tracking |
| | | Boards | tasks within a |
| | | Time tracking: Time Doctor, Hubstaff, | source control management platform. They |
| | | Harvest, Google Calendar | represent changes directly related to the work |
| | | Ci/CD: Azure Devops, Gihub Actions, Gitlab | items. |
| | | Cl/CD, Bitbucket Pipelines | |
| Ongoing KPIs | — | Platform database | Number of KPIs that is running for engineer or |
| | | | team |
| Finished KPIs | — | Platform database | Number of KPIs that is finished for engineer or |
| | | | team |
| Failed KPIs | Negative | Platform database | Number of KPIs that is finished with fail for |
| | | | engineer or team |
| KPI Fail Ratio | Negative | Platform database | Ratio of Failed KPIs to Finished KPIs |
| Industry Insight Mark | Positive | Repository: Github, Gitlab, Bitbucket, Azure | Industry Insight Mark (IIM) is an indicator that |
| | | Issue tracking: Jira, Trello, Asana, Clickup, | measures current industry trends for a specific |
| | | Monday, Teamwork, Github Projects, Gitlab | indicator and shows how an engineer, team, or |
| | | Boards | organization performs compared to the industry |
| | | Time tracking: Time Doctor, Hubstaff, | indicator. |
| | | Harvest, Google Calendar | |
| | | Ci/CD: Azure Devops, Gihub Actions, Gitlab | |
| | | Cl/CD, Bitbucket Pipelines | |
| Average Feedback | Positive | Platform database | The Feedback Score of Engineer refers to the |
| Score | | | average rating or score they receive from team |
| | | | members as feedback. It takes into account the |
| | | | multiple |
| | | | feedback submissions received from different team |
| | | | members. To calculate the |
| | | | average feedback score, a simple approach could |
| | | | be to assign equal weight to each team |
| | | | member's feedback. However, for a more |
| | | | nuanced analysis, |
| | | | weighted average feedback scores can be |
| | | | calculated based on factors such as the team |
| | | | member's role, experience, or expertise. These |
| | | | weights can be |
| | | | determined statistically by analyzing the correlation |
| | | | between a team member's feedback and the |
| | | | overall performance of the engineer, or by using |
| | | | predefined |
| | | | rules that assign higher weights to feedback from |
| | | | senior or specialized team members. The |
| | | | weighted average feedback score provides a |
| | | | more |
| | | | comprehensive evaluation, considering the varying |
| | | | contributions and |
| | | | perspectives of team members in assessing an |
| | | | engineer's performance. Average Feedback Score |
| | | | (E) refers to the average rating or score received |
| | | | for a specific question across all engineers. It |
| | | | represents the collective evaluation of that |
| | | | particular question's feedback across the entire |
| | | | group of engineers. |
| | | | Average Feedback Score (QE) is the average |
| | | | value of the Average Feedback |
| | | | Scores (E) across all questions. It provides an |
| | | | overall assessment by considering the average |
| | | | scores of each question across all engineers, |
| | | | offering a comprehensive measure of the feedback |
| | | | received from the entire group. |
| Budget Spent | Negative | Repository: Github, Gitlab, Bitbucket, Azure | Budget Spent Indicator measures the amount of |
| | | Issue tracking: Jira, Trello, Asana, Clickup, | funds spent on team, infrastructure and other |
| | | Monday, Teamwork, Github Projects, Gitlab | operational costs related to realization of a project. |
| | | Boards | |
| | | Time tracking: Time Doctor, Hubstaff, | |
| | | Harvest, Google Calendar | |
| Engineers Involved | — | Repository: Github, Gitlab, Bitbucket, Azure | Engineers Involved is a metric that shows the |
| | | Issue tracking: Jira, Trello, Asana, Clickup, | number of software engineers involved in a team or |
| | | Monday, Teamwork, Github Projects, Gitlab | organization. |
| | | Boards | |
| Profitability | Positive | Repository: Github, Gitlab, Bitbucket, Azure | Profitability is an indicator that measures the |
| | | Issue tracking: Jira, Trello, Asana, Clickup, | degree to which a team or organization generates |
| | | Monday, Teamwork, Github Projects, Gitlab | profit from their expenditures. |
| | | Boards | |
| | | Time tracking: Time Doctor, Hubstaff, | |
| | | Harvest, Google Calendar | |
| | | Ci/CD: Azure Devops, Gihub Actions, Gitlab | |
| | | Cl/CD, Bitbucket Pipelines | |
| Infrastructure Cost | Negative | Infrastructure: AWS | Infrastructure Cost is a metric used to measure the |
| | | | costs associated with maintaining the technical |
| | | | infrastructure such as servers, databases, |
| | | | software. |
| Budget Spent On Type | — | Repository: Github, Gitlab, Bitbucket, Azure | Budget Spent On Type Of Work is an indicator that |
| Of Work | | Issue tracking: Jira, Trello, Asana, Clickup, | shows how funds have been used across different |
| | | Monday, Teamwork, Github Projects, Gitlab | categories of tasks (planned, unplanned, bugs, |
| | | Boards | refactor). |
| | | Time tracking: Time Doctor, Hubstaff, | |
| | | Harvest, Google Calendar | |
| | | Ci/CD: Azure Devops, Gihub Actions, Gitlab | |
| | | Cl/CD, Bitbucket Pipelines | |
| Total Time Spent | Negative | Repository: Github, Gitlab, Bitbucket, Azure | Total Time Spent is a metric that measures total |
| | | Issue tracking: Jira, Trello, Asana, Clickup, | time spent on all tasks by team or organization. |
| | | Monday, Teamwork, Github Projects, Gitlab | |
| | | Boards | |
| | | Time tracking: Time Doctor, Hubstaff, | |
| | | Harvest, Google Calendar | |
| Task Progress | Positive | Issue tracking: Jira, Trello, Asana, Clickup, | Task Progress measures the percentage of tasks |
| | | Monday, Teamwork, Github | that have been completed at a given period of time. |
| | | Projects, Gitlab Boards | |
| Average Velocity | Negative | Repository: Github, Gitlab, Bitbucket, Azure | Average Velocity is an indicator that measures the |
| | | Issue tracking: Jira, Trello, Asana, Clickup, | average rate at which an engineer is completing |
| | | Monday, Teamwork, Github Projects, Gitlab | work in terms of story points (SP). It provides |
| | | Boards | insights into the productivity and efficiency of the |
| | | | engineer or team in delivering work over a specific |
| | | | time period. |
| Average Sprint Length | — | Issue tracking: Jira, Trello, Asana, Clickup, | Average Sprint Length is the metric that measures |
| | | Monday, Teamwork, Github | the average time spent on sprints for a given period |
| | | Projects, Gitlab Boards | of time. |
| Successful Sprints | Positive | Issue tracking: Jira, Trello, Asana, Clickup, | Successful Sprints Indicator measures the number |
| | | Monday, Teamwork, Github | of development sprints that the team completed |
| | | Projects, Gitlab Boards | fully according to the goals set. |
| Total Sprints | — | Issue tracking: Jira, Trello, Asana, Clickup, | Total Sprints Indicator measures the total number |
| | | Monday, Teamwork, Github | of development sprints over a specific period of |
| | | Projects, Gitlab Boards | time. |
| Active Engineers | — | Repository: Github, Gitlab, Bitbucket, Azure | Active Engineers is the number of engineers |
| | | Issue tracking: Jira, Trello, Asana, Clickup, | currently working in a team or organization. |
| | | Monday, Teamwork, Github Projects, Gitlab | |
| | | Boards | |
| | | Time tracking: Time Doctor, Hubstaff, | |
| | | Harvest, Google Calendar | |
| Tasks Planned | — | Issue tracking: Jira, Trello, Asana, Clickup, | Tasks Planned Indicator measures the number of |
| | | Monday, Teamwork, Github | tasks that have been scheduled for a given period |
| | | Projects, Gitlab Boards | of time. |

In summary, all indicators can be divided into those that have independent categories of sources and those that have dependent categories of sources. This distinction should be considered solely from the perspective of calculating values for the indicator formula.

Let's consider indicators with independent categories of sources: Deployment Frequency, Change Failure Rate, Commented PRs, Linked Data, Unlinked Data, Commits, and Average Feedback Score.

If an indicator has independent categories of sources, we don't need to reconcile values from different categories for the same element of the formula. We use only one category source for each element of the formula in the calculation. Hence, there is no need to define rules for mapping categories of sources.

The next step is to determine the importance of sources and required entities within each source.

This can be illustrated using the “Deployment Frequency” indicator, a DORA metric that measures the frequency of code deployments or releases. This indicator assesses how often software changes are deployed to production, reflecting the organization's ability to deliver updates quickly and consistently.

The calculation process would involve defining the indicator, identifying the source, assigning source and entity priorities, and eventually updating the formula. The prioritization can vary as Low (1 point), Medium (2 points), High (3 points).

Deployment Frequency (DF) is a DORA metric that measures the frequency of code deployments or releases. It assesses how often software changes are deployed to production, reflecting the organization's ability to deliver updates quickly and consistently. A higher DF value signifies a more frequent and efficient deployment process, indicative of successful DevOps practices and continuous delivery.

### Basic Formula:

$$Deployment Frequency = \frac{Number of Deployments}{Time Period ( Days )} ( 1 / D )$$

### Random Example:

$$Deployment Frequency = \frac{20 + 5 + 3 + 17 + 5 + 10 + 10}{7} = \frac{70}{7} = 10 ( 1 / D )$$

Let's consider different cases for calculating the indicator depending on sources and required entities used by the engineer:
Engineer uses only GitHub (source)
Engineer works in a single repository (required entity)
Engineer works in multiple repositories
Engineer uses multiple resources: GitHub, GitLab, Bitbucket
Engineer works in a single repository.
Engineer works in multiple repositories.

The project manager needs to assign priorities to the source (Source, S(i)) and the required entities (Required Entity R(i)) within the source. The available priorities are: Low (1 point), Medium (2 points), High (3 points).

Now let's look at specific examples of the engineer's work:
Engineer works with GitHub, in multiple repositories.
Engineer works with GitHub, GitLab, in multiple repositories.

1. Engineer works with GitHub, in multiple repositories.

First, we identify all deployments that belong to the engineer in each repository on GitHub where the engineer works and which have been integrated into the system. For each repository (Required Entity), we assign the corresponding priorities assigned by the project manager.

Let's assume the engineer works in two repositories (Required Entities):
Priority for working in repository 1: R(1)=High (3 points)
Priority for working in repository 2: R(2)=Low (1 point)

We determine the importance coefficients for each repository, considering that the sum of the coefficients should be equal to 1 for all repositories. The total points for the two entities=4, so the coefficient R(1)=¾=0.75, R(2)=¼=0.25.

Now we can determine the “Deployment Frequency” indicator, taking into account the coefficients for each repository:

$${\sum }_{i = 1}^{N} R * ND \\ DF = \frac{Num \underline{ber of Deployment} s}{Time Period ( days )} = ( {\sum }_{i = 1}^{N} R * ND ) / ( Time Period ( days ) ) \\ DF = ( 0.75 \cdot 10 + 0.25 \cdot 2 ) / 7 = ( 7.5 + 0.5 ) / 7 = 1.14$$

As a result, we find that the engineer performed approximately 1.14 effective deployments per day on average during the week. If we calculate this indicator without considering the importance of required entities, then the engineer performed approximately 12/7=1.71 deployments per day on average during the week.

2. Engineer works with GitHub, GitLab, in multiple repositories.

First, we identify all deployments that belong to the engineer in each repository on GitHub and GitLab where the engineer works and which have been integrated into the system.

For each source and its corresponding repositories, we assign the respective priorities selected by the project manager.

Let's assume the engineer works with two sources:
Priority for working on GitHub: S(1)=High (3 points)
Priority for working on GitLab: S(2)=Low (1 point)

We determine the importance coefficients for each source, considering that the sum of the coefficients should be equal to 1. The total points=4, so the coefficient S(1)=¾=0.75, S(2)=¼=0.25.

Let's assume the engineer works in the first source in two repositories (Required Entities):
Priority for working in repository 1: R(1,1)=High (3 points)
Priority for working in repository 2: R(1,2)=Low (1 point)

We determine the importance coefficients for each repository within source 1, considering that the sum of the coefficients should be equal to 1. The total points=4, so the coefficient R(1,1)=¾=0.75, R(1,2)=¼=0.25.

Let's assume the engineer works in the second source in a single repository (Required Entity), then regardless of the repository's priority for the engineer within the source, the importance coefficient should be 1, i.e., R(2,1)=1.

As a result, we can use the formula for calculation from the previous example.

$$DF = \frac{Number of Deployments}{Time Period ( days )} = {\sum }_{j = 1}^{m} S * {\sum }_{i - 1}^{n} R * {ND}_{ji} = ( 0.75 \cdot ( 0.75 \cdot 10 + 0.25 \cdot 20 ) + 0.25 \cdot 1 \cdot 1 ) / 7 = ( 9.375 + 0.25 ) / 7 = 1.38$$

As a result, we find that the engineer performed approximately 1.38 effective deployments per day on average during the week. If we calculate this indicator without considering the importance of sources and repositories (required entities), then the engineer performed approximately 31/7=4.43 deployments per day on average during the week.

The general formula for indicators that only use Ranging will have the following form:

$$Indicator = {\sum }_{j = 1}^{m} Source Weight * {\sum }_{i = 1}^{n} Required Entity Weight * Formula {Specification}_{i}$$

Source (S) is a resource for a specific category of resources. Source Weight is the importance of a specific resource.

Required Entity (R) is a lower level of resource that an engineer uses to perform the job. For example, a repository is a required entity for GitHub (source). Required Entity Weight is the importance of a specific required entity within a source.

Formula Specification is a basic formula for a specific indicator.

Let's consider an indicator with dependent categories of sources: Bug Fix Time. Let's assume that there is a task to fix a bug called “Fix auth bug” that is displayed in different sources differently, and has different time estimates. In such case we need to apply Mapping algorithm to define the accurate time spent on the task “Fix auth bug”.

For example we have 3 sources from different categories:
Github (cat—REPOSITORIES)
Trello (cat—TASK TRACKING SYSTEM)
Hubstaff (cat—TIME TRACKING SYSTEM)

We identified by PR that the engineer spent 4 h on the part of work called “Fix auth bug”. Also we identified a task that engineer spent 4 h 35 min to finish it that called “Bugfixing-Auth” Also we identified that engineer tracked 4 h 22 min in task “Fixing bug with Auth”

So having all this stuff not connected we identify 3 different activities, but giving an opportunity to connect it between each other we understand that it is the same activity and relying on a TIME TRACKING info we see a clear time spent on it.

So, we need to use the Mapping algorithm to define the primary source and secondary sources, and calculate the estimated time for a given activity.

Let's break this algorithm down step-by-step:
Data Extraction: Extract data from each source (Github, Trello, Hubstaff). The data should ideally contain task identifier (like task description or name) and time spent.
Data Preprocessing: Clean and preprocess the data. Normalize the task descriptions to a common format to make comparisons easier. Also, normalize the time data into a common unit (like minutes or hours).
Task Matching: Create a function to match tasks across different sources. This function should take an identifier and compare it to the task descriptions in each source. The comparison could be an exact match or use some form of fuzzy matching (like Levenshtein distance or cosine similarity).
Time Calculation: Create a function to calculate the total time spent on a task. This function should apply the task matching function to each source and then combine the times.

### Task Matching

This function is a crucial part of the mapping system. Its job is to compare the task identifiers (like descriptions or names) from different sources to find matches. Let's break down the two main approaches:

Exact Match: In this approach, the function compares the task identifiers exactly as they are. If two identifiers are identical, they're considered a match. This is the simplest form of matching but may not work well if the task descriptions vary even slightly across sources. This function would return True if the identifiers match exactly and False otherwise.

Fuzzy Matching: This approach allows for approximate matches, which can be useful if the task descriptions aren't exactly the same but are still referring to the same task.

Two popular techniques for fuzzy matching are:
Levenshtein Distance: This is a measure of the minimum number of single-character edits (insertions, deletions, or substitutions) needed to change one word into the other. The lower the Levenshtein distance, the more similar the words are. You would then consider two tasks a match if their Levenshtein distance is below a certain threshold.
Cosine Similarity: This measures the cosine of the angle between two vectors. In the context of text data, these vectors could be word count vectors, tf-idf vectors, or similar. The closer the cosine similarity is to 1, the more similar the words are. You would then consider two tasks a match if their cosine similarity is above a certain threshold.

Choosing between exact and fuzzy matching (and choosing which fuzzy matching technique to use) would depend on your specific use case. You may want to experiment with different approaches and see which works best for your data.

Dealing with Unmatched Tasks:

If a task in one source does not have a match in another source, one approach could be to treat it as a separate task.

Alternatively, you could review these tasks manually or use more sophisticated matching techniques like machine learning models to predict whether they are the same task.

Creating a robust mapping system involves handling various use cases and edge cases. The precise approach may vary depending on the nature and quality of the data, the reliability of the sources, and the specific requirements of the project. Always validate your approach with sample data before implementing it on the entire dataset, and iteratively refine your methodology based on the results.

Different Approaches to Time Calculation:
Maximum Time: Here, you take the maximum time recorded from the three sources as the accurate time spent. This is based on the presumption that a time tracking tool like Hubstaff would likely capture the most accurate total duration.
Average Time: You could also average the time recorded across all sources. This approach may be useful if all sources are considered equally reliable.
Weighted Average: If some sources are considered more reliable than others, you could assign weights to each source and calculate a weighted average.

Handling Anomalies: Anomalies or outliers in the data need to be handled to prevent skewed results. There are many methods to identify and handle anomalies, such as z-scores, the Interquartile Range method, or even a simple rule like excluding any times that are more than a certain percentage higher or lower than the average. Once identified, anomalies can be ignored, replaced, or adjusted.

Calibration of Primary Sources: To ensure the accuracy of the time estimation, primary sources (the most reliable or important) can be calibrated using secondary sources. The calibration factor is calculated as the average ratio of the times reported by the secondary sources to the primary source. This factor can then be used to adjust the time estimate from the primary source.

Use of Historical Data: Historical data can provide useful insights for identifying anomalies and calibrating primary sources. By analyzing historical data, a typical percentage difference between two sources can be established. This can then be used to identify when a new task's time estimate significantly deviates from the norm, indicating a potential anomaly.

Let's learn in more detail about Weighted Average Time Calculation approach.

First, we define the Time Tracking System as the Primary Source. If there are other sources with estimates for a specific element inside of a specific indicator, we need to use the other sources to calibrate the primary source estimates. Thus, we can calculate a calibration factor that represents the ratio of the time tracked in Hubstaff to the time recorded in the other systems.

Given that you consider Hubstaff as the primary and most reliable source of time tracking, let's assume it reflects the most accurate “real” time an engineer spent on tasks. GitHub and Trello times can be considered as their “perceived” times.

The idea is to understand how much the perceived time deviates from the real time, and then use this deviation to calibrate the primary time source.

Here are the steps to calculate the calibration factor and calibrate the Hubstaff time:
Calculate the Calibration Factors: For both GitHub and Trello, calculate the ratio of their time to the Hubstaff time for the same task. The formula to calculate these factors (k) could be:

$$k\_Github = ( Github Time ) / ( Hubstaff Time )$$

$$k\_Trello = ( Trello Time ) / ( Hubstaff Time )$$

Calculate the Weighted Calibration Factor: To calculate the calibration factor we need to assign weights to each source, and sum up all the weighted calibration factors. This gives you a single calibration factor that represents the weighted average deviation of the other systems from the Primary Source time.
Assign Weights: Based on the reliability or importance of each source, assign a weight to each. Ensure that the sum of all weights equals 1.
Calculate Weighted Calibration Factors: Multiply the calibration factor for each source by its weight.
   weighted_k_GitHub=k_GitHub*weight_GitHub
   weighted_k_Trello=k_Trello*weight_Trello
   ( . . . and so on for each source.)
Calculate Sum of Weighted Calibration Factors: Sum up all the weighted calibration factors. This will give us a single calibration factor that takes into account the relative importance of each source.
Calibrate the Primary Source Time: Multiply the Hubstaff time by the average calibration factor to get the calibrated time.
Calibrated Primary Source Time=Primary Source Time*Sum of Weighted Calibration Factors

This approach assumes that if the Github and Trello times are consistently overestimating or underestimating the time compared to Hubstaff, this calibration factor will correct for that bias.

It would also be ideal to calculate these calibration factors based on multiple tasks to get a more accurate and generalized calibration factor.

Let's consider an example 1:

If the same task is represented in different Task Tracking Systems (Trello and Jira in this case), we would handle it in much the same way as before. We treat each task tracking system as a separate source and include it in our calculations. Here's how we would calculate everything:

Assuming:
Github (G) time=4 h=240 minutes Trello (T) time=4 h 35 min=275 minutes
Hubstaff (H) time=4 h 22 min=262 minutes Jira (J) time=3 h 35 m=215 minutes

Calculate Calibration Factors:
k_Github=Github Time/Hubstaff Time k_Trello=Trello Time/Hubstaff Time
k_Jira=Jira Time/Hubstaff Time

Substituting in the provided values:
k_Github=240 minutes/262 minutes=0.916
k_Trello=275 minutes/262 minutes=1.05
k_Jira=215 minutes/262 minutes=0.82

### Calculate the Weighted Calibration Factor:

Assign Weights:
weight_GitHub: High Priority (3 points) or 0.5
weight_Trello: Medium Priority (2 points) or 0.33
weight_Jira: Low Priority (1 point) or 0.1

Calculate Weighted Calibration Factors
weighted_k_GitHub=k_GitHub*weight_GitHub=0.916*0.5=0.458
weighted_k_Trello=k_Trello*weight_Trello=1.05*0.33=0.3465
weighted_k_Jira=k_Jira*weight_Jira=0.82*0.17=0.1394

Calculate Sum of Weighted Calibration Factors:
Sum of Weighted Calibration Factors=weighted_k_GitHub+weighted_k_Trello+weighted_k_Jira=0.458+0.3465+0.1394=0.9439

Calibrate the Primary Source Time:
Calibrated Time=Hubstaff Time*Sum of Weighted Calibration Factors

Substituting in the Hubstaff time and average calibration factor:
Calibrated Time=262 minutes*0.9439=247.3 minutes or 4 hours and 7 minutes

Let's consider an example 2:

Let's calculate the calibrated time using the weighted average approach, considering the average primary source estimated time.

Assuming:
GitHub (Repositories): 4 h=240 minutes GitLab (Repositories): 3 h 50 m=230 minutes Bitbucket (Repositories): 4 h 10 m=250 minutes
TimeDoctor (Time Tracking System): 4 h 30 m=270 minutes Hubstaff (Time Tracking System): 4 h 22 m=262 minutes Jira (Task Tracking System): 3 h 35 m=215 minutes
Trello (Task Tracking System): 4 h 35 m=275 minutes Clickup (Task Tracking System): 4 h 40 m=280 minutes
GitHub Boards (Task Tracking System): 4 h 15 m=255 minutes Monday (Task Tracking System): 4 h 20 m=260 minutes.

Assuming the weights for each source are as follows:

(These weights can be defined based on the Source Priority and the Required Entity Priority set by the project manager as it was described earlier)
weight_GitHub=0.087
weight_GitLab=0.087
weight_Bitbucket=0.087
weight_TimeDoctor=0.261
weight_Hubstaff=0.261
weight_Jira=0.0435
weight_Trello=0.0435
weight_Clickup=0.0435
weight_GitHubBoards=0.0435
weight_Monday=0.0435

### Calculate Average Primary Source Estimated Time:

$$Primary Source Average Time = ( TimeDoctor Time + Hubstaff Time ) / 2 = ( 270 minutes + 262 minutes ) / 2 = 266 minutes or 4 hours 26 minutes$$

### Calculate Calibration Factors:

$$k\_GitHub = GitHub Time / Primary Source Average Time = 240 minutes / 266 minutes = 0.9023 k\_GitLab = GitLab Time / Primary Source Average Time = 230 minutes / 266 minutes = 0.8647 k\_Bitbucket = BitBucket Time / Primary Source Average Time = 250 minutes / 266 minutes = 0.9398$$

$$k\_TimeDoctor = TimeDoctor Time / Primary Source Average Time = 270 minutes / 266 minutes = 1.015$$

$$k\_Hubstaff = Hubstaff Time / Primary Source Average Time = 262 minutes / 266 minutes = 0.9849$$

$$k\_Jira = Jira Time / Primary Source Average Time = 215 minutes / 266 minutes = 0.8071 k\_Trello = Trello Time / Primary Source Average Time = 275 minutes / 266 minutes = 1.0341 k\_Clickup = Clickup Time / Primary Source Average Time = 280 minutes / 266 minutes = 1.0526 k\_GitHubBoards = GitHub Boards Time / Primary Source Average Time = 255 minutes / 266 minutes = 0.9586$$

$$k\_Monday = Monday Time / Primary Source Average Time = 260 minutes / 266 minutes = 0.9774$$

### Calculate Weighted Calibration Factors:

$$weighted\_k \_GitHub = k\_GitHub * weight\_GitHub = 0.9023 * 0.087 = 0.078407$$

$$weighted\_k \_GitLab = k\_GitLab * weight\_GitLab = 0.8647 * 0.087 = 0.0751509$$

$$weighted\_k \_Bitbucket = k\_Bitbucket * weight\_Bitbucket = 0.9398 * 0.087 = 0.0817514$$

$$weighted\_k \_TimeDoctor = k\_TimeDoctor * weight\_TimeDoctor = 1.015 * 0.261 = 0.265515$$

$$weighted\_k \_Hubstaff = k\_Hubstaff * weight\_Hubstaff = 0.9849 * 0.261 = 0.2568789$$

$$weighted\_k \_Jira = k\_Jira * weight\_Jira = 0.8071 * 0.0435 = 0.0351339$$

$$weighted\_k \_Trello = k\_Trello * weight\_Trello = 1.0341 * 0.0435 = 0.0449314$$

$$weighted\_k \_Clickup = k\_Clickup * weight\_Clickup = 1.0526 * 0.0435 = 0.045621$$

$$weighted\_k \_GitHubBoards = k\_GitHubBoards * weight\_GitHubBoards = 0.9586 * 0.0435 = 0.0416921$$

$$weighted\_k \_Monday = k\_Monday * weight\_Monday = 0.9774 * 0.0435 = 0.0425029$$

### Calculate Sum of Weighted Calibration Factors:

$$Sum of Weighted Calibration Factors = weighted\_k \_GitHub + weighted\_k \_GitLab + weighted\_k \_Bitbucket + weighted\_k \_TimeDoctor + weighted\_k \_Hubstaff + weighted\_k \_Jira + weighted\_k \_Trello + weighted\_k \_Clickup + weighted\_k \_GitHubBoards + weighted\_k \_Monday = 0.078407 + 0.0751509 + 0.0817514 + 0.265515 + 0.2568789 + 0.0351339 + 0.0449314 + 0.045621 + 0.0416921 + 0.0425029 = 1.027$$

Calibrate the Primary Source Time:
Calibrated Time=Primary Source Average Time*Sum of Weighted
Calibration Factors=266 minutes*1.027=272.94 minutes or approximately 4 hours and 33 minutes.

So, based on the example and the provided weights, the calibrated time estimate for the task would be approximately 272.94 minutes or around 4 hours and 33 minutes.

### Explanation to Example 2

The calibration factor is typically used to align secondary sources to a primary source, which serves as the “truth” or reference point. In this case, TimeDoctor and Hubstaff are the primary sources, so we might not need to calibrate them.

However, we're also taking an average of the two primary sources, so in a sense, we're using that average as the new “primary” reference. So, in this context, we're calibrating the individual TimeDoctor and Hubstaff values to that average.

Here's a step back to see the larger picture. Let's say we have multiple sources, some more reliable (primary) than others (secondary). Our goal is to create a ‘unified’ or ‘calibrated’ measure of the task duration that takes into account all these sources but weights the more reliable ones more heavily.

We start with our primary sources, TimeDoctor and Hubstaff, and take an average. We're saying, “These are our most trusted sources, so we'll consider their average as our starting point or our initial ‘best estimate’ of the task duration.”

But we also have information from other sources, and we don't want to waste that. So, we see how each source, including TimeDoctor and Hubstaff, differs from our ‘best estimate.’ That's the calibration factor.

However, we trust some sources more than others. So we weight each source's calibration factor by its weight. Then we average those weighted factors to get a ‘consensus’ factor that respects each source according to its weight.

Finally, we apply this ‘consensus’ calibration factor to our initial ‘best estimate’ from the primary sources to get our final, unified, ‘calibrated’ task duration.

In summary, the reason we're including TimeDoctor and Hubstaff in the calibration process is to incorporate all available information, both primary and secondary sources, into a unified task duration estimate, which respects each source according to its reliability or importance.

If you don't have primary sources at all, but you have secondary sources, you have a few options:

Consider One of the Secondary Sources as Primary: You can assign one of the secondary sources as the primary source based on factors such as its reliability, frequency of updates, or other relevant aspects. The other sources will then be calibrated to this new primary source. Also, we can automatically select the Primary Source based on the Source Priority set by the project manager. You can use this method when the secondary source 1 priority is higher than the secondary source 2 priority.

Use the Average of All Sources as the Primary Source: If all sources are deemed equally reliable, you could take the average of all secondary sources as your reference point. Then, calculate the calibration factors and calibrate each source to this average.

Assign Weights Based on Reliability and Use Weighted Average as Primary: If some sources are more reliable than others, you can assign weights accordingly and calculate a weighted average of all sources. This weighted average would then be your reference point for calibration.

Let's go with the second option for simplicity, and revisit the example using the times from GitHub, GitLab, Bitbucket, Jira, Trello, Clickup, GitHub Boards, and Monday.

First, calculate the average time from all sources, this will be our reference:

$$Average Time = ( Sum of all source times ) / ( Number of source ) = ( 240 + 230 + 250 + 215 + 275 + 280 + 255 + 2 \; 60 ) / 8 = 250.63 minutes$$

Now, calculate the calibration factors for each source as k_Source=Source Time/Average Time.

After that, calculate the weighted calibration factors for each source as Weighted_k_Source=k_Source*weight_Source.

Then, calculate the sum of weighted calibration factors and use it to calibrate the Average Time. The steps are the same as previously described, except we're now using the average of all sources as our reference point instead of the primary source time. The final calibrated time will provide a balanced, calibrated estimate of the task duration based on all available secondary sources.

Let's learn more about Handling Anomalies in estimates.

Handling anomalies is an important part of data cleaning and preprocessing, especially when dealing with data from multiple sources. The approach can vary depending on the nature of your data and the specific application.

Let's consider an example 1:

We have time_Hubstaff and time_GitHub. Here's a general method you could use in this scenario. We'll call the two time estimates time_Hubstaff and time_GitHub.

Set a Threshold for Anomalies: This could be a simple rule like “any time estimate that is less than half or more than twice the other is considered an anomaly.”

Check Each Time Estimate Against the Threshold: For each time estimate, if it's less than half or more than twice the other time estimate, mark it as a potential anomaly. In code, it might look something like this:
if time_GitHub<0.5*time_Hubstaff or time_GitHub>2.0*time_Hubstaff: anomaly_GitHub=True else: anomaly_GitHub=False

Handle the Anomalies: If a time estimate is marked as an anomaly, decide how to handle it. Here are a few options:

Ignore It: Simply exclude it from the calculation of the average time and calibration factor.

Replace It: Replace the anomalous time estimate with a value derived from the non-anomalous time estimate. For instance, you could replace time_GitHub with time_Hubstaff if time_GitHub is the anomaly.

Cap It: If the time estimate is an anomaly because it's too high, cap it at 2.0*time_Hubstaff. If it's too low, set a floor at 0.5*time_Hubstaff.

Calculate the Average Time and Calibration Factor: Once you've handled the anomalies, proceed with the calculation of the average time and calibration factor as before.

The chosen thresholds of 0.5 (half) and 2.0 (double) were arbitrary and served as a simple example. They may not be appropriate in all contexts.

In a more statistically rigorous approach, we might use concepts such as z-scores, standard deviations, or Interquartile Range (IQR) to detect outliers. However, these methods typically require a larger sample size to be effective and may not be as useful when dealing with only two data points.

When only two data points are available, identifying one as an anomaly becomes a bit subjective and dependent on domain knowledge. We might have to rely on heuristics or rules of thumb, like the 0.5 and 2.0 factors used in the example. However, these thresholds could be adjusted based on your knowledge of the task and the characteristics of the sources.

Another way could be comparing the two data points with historical data, if available, from both sources for similar tasks. If one source is consistently higher or lower than the other for similar tasks, it could help in determining whether a large discrepancy in a new task is an anomaly or a consistent bias.

For instance, if GitHub's times are consistently 30% lower than Hubstaff's times across many tasks, then seeing a GitHub time that is 50% of a Hubstaff time for a new task might not be considered an anomaly. Conversely, if the two sources usually report similar times, then a large discrepancy could be considered anomalous.

However, keep in mind that with only two data points, it's hard to make statistically sound judgments about anomalies. A larger sample size would provide more confidence in the analysis.

When calculating such historical comparisons, you would first want to ensure that you are working with clean, reliable data. This means you would typically exclude anomalies or outliers from your historical dataset first before performing any analysis.

Here's how you might approach it:

Compile your historical data: Collect the time records from both GitHub and Hubstaff across many similar tasks.

Clean the data: Implement an anomaly detection method to identify and remove outliers from your dataset. There are many approaches to this, including z-scores, the IQR method, or even a simple rule like excluding any times that are more than a certain percentage higher or lower than the average.

Calculate the historical comparison value: After cleaning the data, calculate the average time for each source across all the tasks. Then, calculate the percentage difference between these two averages.

Let's say you find that, on average, GitHub times are 30% lower than Hubstaff times. This means that, in general, GitHub tends to report times that are about 30% less than Hubstaff for similar tasks.

Then, when you get a new pair of time estimates from GitHub and Hubstaff for a new task, you can compare them to this historical comparison value. If the GitHub time is significantly lower than the Hubstaff time-more than the usual 30% it might be considered an anomaly. If it's around 30% lower, it could be considered normal.

Let's consider an example 2:

Let's consider that we have identified anomalies in the time estimates of 2 sources—GitLab and Jira, where their reported times are unusually high, which may have occurred due to some data glitches or incorrect entries.

Assuming:
GitLab (Repositories): 10 h=600 minutes
Jira (Task Tracking System): 8 h=480 minutes

First, let's update the time estimates with the detected anomalies:
GitHub (Repositories): 240 minutes
GitLab (Repositories): 600 minutes (Anomaly) Bitbucket (Repositories): 250 minutes TimeDoctor (Time Tracking System): 270 minutes Hubstaff (Time Tracking System): 262 minutes
Jira (Task Tracking System): 480 minutes (Anomaly) Trello (Task Tracking System): 275 minutes
Clickup (Task Tracking System): 280 minutes GitHub Boards (Task Tracking System): 255 minutes Monday (Task Tracking System): 260 minutes

Detect anomalies statistically:

First, we calculate the mean:

$$Mean = Sum of all estimates / number of estimates = ( 240 + 600 + 250 + 270 + 262 + 480 + 275 + 280 + 255 + 2 \; 60 ) / 10 = 3 \; 172 / 10 = 317.2 minutes$$

Now, we calculate the standard deviation (SD). For this, we need to calculate the variance first:

$$Variance = Sum of ( ( each estimate - mean ) ⋀ 2 ) / number of estimates = ( ( 240 - 317.2 ) \hat{} 2 + ( 600 - 317.2 ) ⋀ 2 + ( 250 - 317.2 ) ⋀ 2 + ( 270 - 317.2 ) ⋀ 2 + ( 262 - 317.2 ) ⋀ 2 + ( 480 - 317.2 ) ⋀ 2 + ( 275 - 317.2 ) ⋀ 2 + ( 280 - 317.2 ) ⋀ 2 + ( 255 - 317.2 ) ⋀ 2 + ( 260 - 317.2 ) ⋀ 2 ) / 10 = 18144.8 minutes ⋀ 2.$$

$$Standard Deviation = sqrt ( Variance ) = sqrt ( 18144.8 ) = 134.7 minutes$$

For a 95% percentile threshold, the z-score threshold is approximately 1.96 (based on the standard normal distribution).

Now we calculate the z-scores for each estimate:

$$Z\_GitHub = ( GitHub Time - Mean ) / SD = ( 240 - 317.2 ) / 134.7 = - 0.573$$

$$Z\_GitLab = ( GitLab Time - Mean ) / SD = ( 600 - 317.2 ) / 134.7 = 2.1$$

$$Z\_Bitbucket = ( Bitbucket Time - Mean ) / SD = ( 250 - 317.2 ) / 134.7 = - 0.498$$

$$Z\_TimeDoctor = ( TimeDoctor Time - Mean ) / SD = ( 270 - 317.2 ) / 134.7 = - 0.35$$

$$Z\_Hubstaff = ( Hubstaff Time - Mean ) / SD = ( 262 - 317.2 ) / 134.7 = - 0.41$$

$$Z\_Jira = ( Jira Time - Mean ) / SD = ( 480 - 317.2 ) / 134.7 = 1.21$$

$$Z\_Trello = ( Trello Time - Mean ) / SD = ( 275 - 317.2 ) / 134.7 = - 0.314$$

$$Z\_Clickup = ( Clickup Time - Mean ) / SD = ( 280 - 317.2 ) / 134.7 = - 0.277$$

$$Z\_GitHubBoards = ( GitHubBoards Time - Mean ) / SD = ( 255 - 317.2 ) / 134.7 = - 0.462$$

$$Z\_Monday = ( Monday Time - Mean ) / SD = ( 260 - 317.2 ) / 134.7 = - 0.426$$

So, looking at the z-scores, we can confirm that GitLab (Z=2.10) is indeed anomaly as its z-score is above the 1.96 threshold.

To handle the anomalies, we could replace the anomalous values with the mean time estimate (this is just one possible approach). So, the adjusted times would be:
GitLab (Repositories): 317.2 minutes

Alternatively, you can exclude anomalies from the steps below.

Now, you can proceed with the weighted average calculation as before, using these adjusted time estimates, to find the calibrated time. However, we have not found the Jira estimate as anomaly, therefore, we need to make some updates for the anomaly detection algorithm.

Let's consider an example 3:

### Iteration 1

Let's start by calculating the average primary source estimated time, which consists of the TimeDoctor and Hubstaff time tracking systems.

$$Primary Source Average Time = ( TimeDoctor Time + Hubstaff Time ) / 2 = ( 270 minutes + 262 minutes ) / 2 = 266 minutes or 4 hours and 26 minutes$$

Next, let's calculate the calibration factors for each source, which are the ratios of each source's time estimate to the primary source average time.

$$k\_GitHub = GitHub Time / Primary Source Average Time = 240 minutes / 266 minutes = 0.9023$$

$$k\_GitLab = GitLab Time / Primary Source Average Time = 600 minutes / 266 minutes = 2.2556$$

$$k\_Bitbucket = Bitbucket Time / Primary Source Average Time = 250 minutes / 266 minutes = 0.9398$$

$$k\_TimeDoctor = TimeDoctor Time / Primary Source Average Time = 270 minutes / 266 minutes = 1.015$$

$$k\_Hubstaff = Hubstaff Time / Primary Source Average Time = 262 minutes / 266 minutes = 0.9849$$

$$k\_Jira = Jira Time / Primary Source Average Time = 480 minutes / 266 minutes = 1.8045$$

$$k\_Trello = Trello Time / Primary Source Average Time = 275 minutes / 266 minutes = 1.0341$$

$$k\_Clickup = Clickup Time / Primary Source Average Time = 280 minutes / 266 minutes = 1.0526$$

$$k\_GitHubBoards = GitHub Boards Time / Primary Source Average Time = 255 minutes / 266 minutes = 0.9586$$

$$k\_Monday = Monday Time / Primary Source Average Time = 260 minutes / 266 minutes = 0.9774$$

Now let's calculate the mean and standard deviation of these calibration factors:

$$Mean of calibration factors = ( 0.9023 + 2.2556 + 0.9398 + 1.015 + \\ 0.9849 + 1.8045 + 1.0341 + 1.0526 + 0.9586 + 0.9774 ) / 10 = 1.0925$$

$$Standard deviation of calibration factors = sqrt ( ( {( 0.9023 - 1.0925 )}^{2} + {( 2.2556 - 1.0925 )}^{2} + {( 0.9398 - 1.0925 )}^{2} + {( 1.015 - 1.0925 )}^{2} + {( 0.9849 - 1.0925 )}^{2} + {( 1.8045 - 1.0925 )}^{2} + {( 1.0341 - 1.0925 )}^{2} + {( 1.0526 - 1.0925 )}^{2} + {( 0.9586 - 1.0925 )}^{2} + {( 0.9774 - 1.0925 )}^{2} ) / 9 ) = 0.4021$$

Then, we calculate the z-scores for each calibration factor, which is the number of standard deviations each calibration factor deviates from the mean. We will use a z-score of 1.96 as our anomaly threshold, representing the 95th percentile under the standard normal distribution.

$$z\_GitHub = ( 0.9023 - 1.0925 ) / 0.4021 = - 0.4727$$

$$z\_GitLab = ( 2.2556 - 1.0925 ) / 0.4021 = 2.8883$$

$$z\_Bitbucket = ( 0.9398 - 1.0925 ) / 0.4021 = - 0.3799$$

$$z\_TimeDoctor = ( 1.015 - 1.0925 ) / 0.4021 = - 0.1927$$

$$z\_Hubstaff = ( 0.9849 - 1.0925 ) / 0.4021 = - 0.2676$$

$$z\_Jira = ( 1.8045 - 1.0925 ) / 0.4021 = 1.7702$$

$$z\_Trello = ( 1.0341 - 1.0925 ) / 0.4021 = - 0.1451$$

$$z\_Clickup = ( 1.0526 - 1.0925 ) / 0.4021 = - 0.0991$$

$$z\_GitHubBoards = ( 0.9586 - 1.0925 ) / 0.4021 = - 0.3332$$

$$z\_Monday = ( 0.9774 - 1.0925 ) / 0.4021 = - 0.2865$$

Based on these z-scores, GitLab is the only anomaly, as its z-score is above the 1.96 Threshold.

### Iteration 2

Repeat the previous steps for all sources after excluding the Gitlab time estimates Let's follow through the steps with the given data.

Calculate the average primary source estimate:
The primary sources are TimeDoctor and Hubstaff.

$$Primary Source Average Time = ( TimeDoctor Time + Hubstaff Time ) / 2$$

$$Primary Source Average Time = ( 270 minutes + 262 minutes ) / 2 = 266 minutes$$

Calculate the calibration factors for each source:

The calibration factor (k) for each source is calculated as the estimated time from each source divided by the average estimated time from the primary sources.

$$k\_GitHub = GitHub Time / Primary Source Average Time = 240 minutes / 266 minutes = 0.9023$$

$$k\_Bitbucket = Bitbucket Time / Primary Source Average Time = 250 minutes / 266 minutes = 0.9398$$

$$k\_Jira = Jira Time / Primary Source Average Time = 480 minutes / 266 minutes = 1.8045$$

$$k\_Trello = Trello Time / Primary Source Average Time = 275 minutes / 266 minutes = 1.0341$$

$$k\_Clickup = Clickup Time / Primary Source Average Time = 280 minutes / 266 minutes = 1.0526$$

$$k\_GitHubBoards = GitHub Boards Time / Primary Source Average Time = 255 minutes / 266 minutes = 0.9586$$

$$k\_Monday = Monday Time / Primary Source Average Time = 260 minutes / 266 minutes = 0.9774$$

$$k\_TimeDoctor = TimeDoctor Time / Primary Source Average Time = 270 minutes / 266 minutes = 1.015$$

$$k\_Hubstaff = Hubstaff Time / Primary Source Average Time = 262 minutes / 266 minutes = 0.9849$$

Calculate the z-scores for calibration factors:

Now we can include these values in our mean and standard deviation calculations:

The updated mean (μ) is: (0.9023+0.9398+1.8045+1.0341+1.0526+0.9586+0.9774+1.015+0.9849)/9=1.0748

The standard deviation (SD) is: sqrt[((0.9023−1.0748)²+(0.9398−1.0748)²+(1.8045−1.0748)²+(1.0341−1.0748)²+(1.0526−1.0748)²+(0.9586−1.0748)²+(0.9774−1.0748)²+(1.015−1.0748)²+(0.9849−1.0748)²)/8]=0.2617

Then, we can calculate the z-scores for each calibration factor:

$$z\_GitHub = ( 0.9023 - 1.0748 ) / 0.2617 = - 0.659$$

$$z\_Bitbucket = ( 0.9398 - 1.0748 ) / 0.2617 = - 0.515$$

$$z\_TimeDoctor = ( 1.015 - 1.0748 ) / 0.2617 = - 0.228$$

$$z\_Hubstaff = ( 0.9849 - 1.0748 ) / 0.2617 = - 0.343$$

$$z\_Jira = ( 1.8045 - 1.0748 ) / 0.2617 = 2.787$$

$$z\_Trello = ( 1.0341 - 1.0748 ) / 0.2617 = - 0.155$$

$$z\_Clickup = ( 1.0526 - 1.0748 ) / 0.2617 = - 0.085$$

$$z\_GitHubBoards = ( 0.9586 - 1.0748 ) / 0.2617 = - 0.444$$

$$z\_Monday = ( 0.9774 - 1.0748 ) / 0.2617 = - 0.372$$

As we can see, Jira with z-score 2.787 is above the usual threshold of 1.96 and is an anomaly. So we exclude Jira.

### Iteration 3

Our new list for the 3rd iteration is:

$$GitHub Boards ( Task Tracking System ) : 4 h 15 m = 255 minutes Monday ( Task Tracking System ) : 4 h 20 m = 260 minutes .$$

$$GitHub ( Repositories ) : 4 h = 240 minutes Bitbucket ( Repositories ) : 4 h 10 m = 250 minutes .$$

$$TimeDoctor ( Time Tracking System ) : 4 h 30 m = 270 minutes Hubstaff ( Time Tracking System ) : 4 h 22 m = 262 minutes .$$

$$Trello ( Task Tracking System ) : 4 h 35 m = 275 minutes Clickup ( Task Tracking System ) : 4 h 40 m = 280 minutes .$$

We can then repeat the process: calculating the new mean for the primary source estimate, deriving the calibration factors, and determining the z-scores. We continue this process until we no longer find any anomalies.

### Step 1: Average Primary Source Estimate

Our primary sources are TimeDoctor and Hubstaff:

$$Primary Source Average = ( TimeDoctor Time + Hubstaff Time ) / 2 = ( 270 minutes + 262 minutes ) / 2 = 266 minutes$$

### Step 2: Calculating Calibration Factors

Calibration factors are the ratio of the given time estimate to the primary source average. We have:

$$k\_GitHub = GitHub Time / Primary Source Average Time = 240 / 266 = 0.9023$$

$$k\_Bitbucket = Bitbucket Time / Primary Source Average Time = 250 / 266 = 0.9398$$

$$k\_Trello = Trello Time / Primary Source Average Time = 275 / 266 = 1.0341$$

$$k\_Clickup = Clickup Time / Primary Source Average Time = 280 / 266 = 1.0526$$

$$k\_GitHubBoards = GitHub Boards Time / Primary Source Average Time = 255 / 266 = 0.9586$$

$$k\_Monday = Monday Time / Primary Source Average Time = 260 / 266 = 0.9774$$

$$k\_TimeDoctor = TimeDoctor Time / Primary Source Average Time = 270 / 266 = 1.015$$

$$k\_Hubstaff = Hubstaff Time / Primary Source Average Time = 262 / 266 = 0.9849$$

Step 3: Calculating z-Scores for Calibration Factors

First, we need the mean of the calibration factors:

$$Mean of Calibration Factors = ( 0.9023 + 0.9398 + 1.0341 + 1.0526 + 0.9586 + 0.9774 + 1.015 + 0.9849 ) / 8 = 0.9706$$

Next, we calculate the standard deviation of the calibration factors:

$$Standard Deviation = sqrt ( ( sum ( ( xi - mean ) ⋀ 2 ) ) / n ) = sqrt ( ( ( 0.9023 - 0.9706 ) ⋀ 2 + ( 0.9398 - 0.9706 ) ⋀ 2 + ( 1.0341 - 0.9706 ) ⋀ 2 + ( 1.0526 - 0.9706 ) ⋀ 2 + ( 0.9586 - 0.9706 ) ⋀ 2 + ( 0.9774 - 0.9706 ) ⋀ 2 + ( 1.015 - 0.9706 ) ⋀ 2 + ( 0.9849 - 0.9706 ) ⋀ 2 ) / 8 ) = sqrt ( ( 0.00465841 + 0.00094944 + 0.00402121 + 0.00671824 + 0.00014436 + 0.00004624 + 0.00197844 + 0.00020449 ) / 8 ) = sqrt ( 0.00234024 ) = 0.04837$$

Next, the z-scores are calculated as follows:

$$z\_GitHub = ( 0.9023 - 0.9706 ) / 0.04837 = - 1.41$$

$$z\_Bitbucket = ( 0.9398 - 0.9706 ) / 0.04837 = - 0.64$$

$$z\_Trello = ( 1.0341 - 0.9706 ) / 0.04837 = 1.31$$

$$z\_Clickup = ( 1.0526 - 0.9706 ) / 0.04837 = 1.69$$

$$z\_GitHubBoards = ( 0.9586 - 0.9706 ) / 0.04837 = - 0.25$$

$$z\_Monday = ( 0.9774 - 0.9706 ) / 0.04837 = 0.14$$

$$z\_TimeDoctor = ( 1.015 - 0.9706 ) / 0.04837 = 0.92$$

$$z\_Hubstaff = ( 0.9849 - 0.9706 ) / 0.04837 = 0.3$$

### Step 4: Excluding Anomalies

Using a threshold of z=1.96 for a 95% confidence level, we find that there are no more anomalies among the sources. All z-scores are within the acceptable range.

In conclusion, at the end of the 3rd iteration, all sources are considered non-anomalous according to the z-score methodology with a 95% confidence level.

Here are the main conclusions we've drawn from this task:

Iterative Anomaly Detection: Using a process of iterative anomaly detection based on z-scores was very effective in removing outlying estimates from the data set. By successively recalculating the primary source average estimate, calibration factors, and z-scores after each iteration, we were able to systematically identify and remove anomalies. In addition, we can apply machine learning techniques to detect anomalies. The ML approach is more advanced and can be applied too.

Use of Calibration Factors: The use of calibration factors is key to finding and understanding discrepancies between the various time estimation sources. It helps to identify how much each source typically deviates from the primary source, and makes it easier to detect significant anomalies that might affect our analysis.

Reliance on Primary Sources: Focusing on estimates from primary sources (TimeDoctor and Hubstaff in our case) helped to create a reliable baseline for comparing and understanding time estimates from other sources.

Role of Z-Scores: Z-scores provide a standard metric that allows for the identification of outliers based on a chosen threshold. In our case, we used a threshold of 1.96, which corresponds to 95% of the data in a normal distribution.

Importance of Multiple Iterations: The task demonstrated the importance of performing multiple iterations of the anomaly detection process. Initial rounds removed clear outliers, but subsequent iterations were needed to refine the data set and eliminate more subtle anomalies.

Need for Historical Data: When available, historical data could potentially provide additional insights, such as the typical range of calibration factors for each source, which could further improve the accuracy of anomaly detection. However, even without historical data, we can still perform a robust analysis using statistical techniques.

The Mapping Algorithm described above can be applied to any indicator, you just need to replace Time Estimate in the example with the corresponding Indicator Element.

To incorporate the notion of gamification into this system, the following are added to the system: point systems, badges, leaderboards, and challenges that encourage users to interact more deeply with the system and aim for optimal use of resources. The specifics of these gamified elements can depend on the context of the system and its users, but here are some ideas:
Point Systems: Users could earn points for optimizing the use of resources within categories and for maintaining low Change Failure Rates or high Deployment Frequencies. They could also earn points for minimizing the Lead Time for Changes and for their contributions to discussions in PRs Commented, Linked Data, and Unlinked Data.

Badges: Badges could be awarded to users who consistently deliver excellent performances in certain areas such as a high Mean Time To Recovery or excellent feedback scores. For example, a “Speedy Recovery” badge could be awarded to those with the shortest Mean Time To Recovery.

Leaderboards: A leaderboard could be implemented to provide a competitive aspect and encourage users to optimize their use of resources. There could be different leaderboards for different indicators, or even a comprehensive leaderboard that aggregates scores across multiple indicators.

Challenges: Users could be set challenges to encourage behaviors that result in the better use of resources. For instance, a challenge might be to improve the Deployment Frequency by a certain percentage over a specific period.

Moreover, these gamified elements could be tailored according to the importance and priority of the sources and entities as assigned by the project manager, to encourage work where it is most needed. For instance, more points could be awarded for improvements in higher-priority areas.

The gamified elements would also need to be displayed visually in a user-friendly and engaging way, possibly with real-time updates to make it exciting for users. This could be achieved through the use of interactive dashboards, progress bars, or visual achievement maps.

Below is a list of metrics and the effect of each metric on a user score. A few examples are provided to illustrate the meaning of the information in the table below. In the first example we look at a positive metric, Efficiency. The Efficiency metric is a positive metric because it is desirable that a user's efficiency increases over time. In the second example we look at a negative metric, Bugs Detected. The Bugs Detected metric is negative because it is not desirable that a user's count of bugs detected increases over time. In a third example we look at a neutral example, Number of Sprints. The number of sprints is a neutral metric because it is not necessarily desirable or undesirable that a user's number of sprints increases or decreases over time.

| | User Score | | |
|---|---|---|---|
| Metric | Effect | Customer Sources | Definition |
| Focused Time | Positive | Repository: Github, Gitlab, Bitbucket, Azure | Focused Time is a metric that measures time of |
| | | Issue tracking: Jira, Trello, Asana, Clickup, | focused and intensive work by an individual |
| | | Monday, Teamwork, Github Projects, Gitlab | engineer. Focused and intensive work can be |
| | | Boards | defined as a tracked work on the tasks the are |
| | | Time tracking: Time Doctor, Hubstaff, | related to the main goals of project or tasks with |
| | | Harvest, Google Calendar | the highest priority. So to calculate Focused Time |
| | | | we need to sum up hours spent at those tasks. |
| | | | Also we should exclude inactive hours tracked on |
| | | | timetracking systems. |
| Poor Time | Negative | Repository: Github, Gitlab, Bitbucket, Azure | Poor Time is a metric that measures the time of |
| | | Issue tracking: Jira, Trello, Asana, Clickup, | poor and low activity by an individual engineer. |
| | | Monday, Teamwork, Github Projects, Gitlab | Poor time and low activity can be defined as a work |
| | | Boards | that was done on tasks with low priority, edited time |
| | | Time tracking: Time Doctor, Hubstaff, | in time-tracking systems, tracked time on breaks. |
| | | Harvest, Google Calendar | |
| Working Days | Positive | Repository: Github, Gitlab, Bitbucket, Azure | Working Days is a metric that measures the |
| | | Issue tracking: Jira, Trello, Asana, Clickup, | number of days when some work was done by an |
| | | Monday, Teamwork, Github Projects, Gitlab | individual engineer. Especially we can define |
| | | Boards | Working day as a day when the individual engineer |
| | | Time tracking: Time Doctor, Hubstaff, | tracked at least 8 hours on the defined tasks. |
| | | Harvest, Google Calendar | |
| Meeting Break Time | Positive | Time tracking: Google Calendar | Meeting break time is a metric that measures |
| | | | time spent on other activities between the |
| | | | meetings by an individual engineer. To calculate |
| | | | this metric we |
| | | | should define the time spent on the meeting per |
| | | | one day and the time when the engineer finished |
| | | | his working day. |
| Hours Overtime | Positive | Repository: Github, Gitlab, Bitbucket, Azure | Hours overtime is a metric that measures the |
| | | Issue tracking: Jira, Trello, Asana, Clickup, | excess time spent on work by an individual |
| | | Monday, Teamwork, Github Projects, Gitlab | engineer. Hours overtime can be defined as time |
| | | Boards | was tracked more than normal working day (8 |
| | | Time tracking: Time Doctor, Hubstaff, | hours). |
| | | Harvest, Google Calendar | |
| Code Churn | Positive | Repository: Github, Gitlab, Bitbucket, Azure | Code churn is a metric that measures the |
| | | | percentage of changes made in existing files by an |
| | | | individual engineer over 21-days period. |
| Coding Days | Positive | Repository: Github, Gitlab, Bitbucket, Azure | Coding days is a metric that measures the |
| | | | number of days when the work related to do |
| | | | coding was done by an individual engineer. |
| | | | Coding days can be |
| | | | defined as a days when on work related to coding |
| | | | was tracked at least 8 hours, so to calculate this |
| | | | metric we should detect is there any work on the |
| | | | ticket |
| | | | related to coding, any commits, any pull requests |
| | | | etc. And then we should sum up hours spent on |
| | | | such activities and define number of days spent |
| | | | from hours tracked. |
| Commits | Positive | Repository: Github, Gitlab, Bitbucket, Azure | Commits are individual changes made to a |
| | | | version-controlled code repository. |
| | | | They represent a unit of work that includes adding, |
| | | | modifying, or deleting code files. Each commit |
| | | | typically has a unique identifier and is associated |
| | | | with a commit message that describes the changes |
| | | | made. |
| PR Merged | Positive | Repository: Github, Gitlab, Bitbucket, Azure | PR Merged is a metric that measures the number |
| | | | of prs merged by an engineer. |
| PR Reviewed | Positive | Repository: Github, Gitlab, Bitbucket, Azure | PR Reviewed is a metric that measures the |
| | | | number of prs of this engineer |
| | | | that had been reviewed |
| Large PRs | Negative | Repository: Github, Gitlab, Bitbucket, Azure | Large PRs is a metric that measures number of |
| | | | large prs created by an individual engineer. A pull |
| | | | request that changes more than 500 lines of codes |
| | | | could be considered as “large”. This threshold |
| | | | value could be tuned for a specific engineer, team |
| | | | or organization. |
| Inactive PRs | Negative | Repository: Github, Gitlab, Bitbucket, Azure | Inactive Prs is a metric that measures the number |
| | | | PRs that are inactive for some period of time by |
| | | | an individual engineer. The optimal period of time to |
| | | | consider a pull request as inactive is one week, |
| | | | however, this value could be tuned for a specific |
| | | | engineer, team or organization. |
| Cycled PR Reviews | Negative | Repository: Github, Gitlab, Bitbucket, Azure | Cycled Review PRs is a metric that measures |
| | | | number of prs that went through review more than |
| | | | 3 times by an individual engineer. The number of |
| | | | cycles could be tuned for a specific engineer, team |
| | | | or organization. |
| Overcommented PRs | Negative | Repository: Github, Gitlab, Bitbucket, Azure | Overcommented PRs is a metric that measures |
| | | | number of PRs that have a large amount of |
| | | | comments by an individual engineer. To consider |
| | | | a pull |
| | | | requests as an overcommented one, there should |
| | | | be at least 15 comments per PR. |
| PR Cycle Time | Negative | Repository: Github, Gitlab, Bitbucket, Azure | PR Open is a metric that measures the average |
| | | | time it takes to open a pull request by an individual |
| | | | engineer. |
| | | | PR Review is a metric that measures the average |
| | | | time it takes to review a pull request by an |
| | | | individual engineer. |
| | | | PR Merged is a metric that measures the average |
| | | | time it takes to merge a pull request by an |
| | | | individual engineer. |
| | | | PR Closed is a metric that measures the average |
| | | | time it takes to close a pull request by an individual |
| | | | engineer. |
| Tasks Done | Positive | Issue tracking: Jira, Trello, Asana, Clickup, | Tasks Done (or Tasks Closed) is a metric that |
| | | Monday, Teamwork, Github | measures the number of completed tasks by an |
| | | Projects, Gitlab Boards | individual engineer. |
| Deployment | Positive | Repository: Github, Gitlab, Bitbucket, Azure | Deployment Frequency (DF) is a DORA metric that |
| Frequency | | Ci/CD: Azure Devops, Gihub Actions, Gitlab | measures the frequency of code deployments or |
| | | Cl/CD, Bitbucket Pipelines | releases. It assesses how often software changes are |
| | | | deployed to production, reflecting the |
| | | | organization's ability to deliver updates quickly |
| | | | and consistently. A higher DF value signifies a |
| | | | more frequent and |
| | | | efficient deployment process, indicative of |
| | | | successful DevOps practices and continuous |
| | | | delivery. |
| Lead Time For | Negative | Repository: Github, Gitlab, Bitbucket, Azure | Lead Time for Changes (LT) refers to the elapsed |
| Changes | | Ci/CD: Azure Devops, Gihub Actions, Gitlab | time from the initiation of a change request or task |
| | | Cl/CD, Bitbucket Pipelines | to its completion by an individual engineer. It |
| | | | measures the duration taken by the engineer to |
| | | | implement and deliver the requested changes or |
| | | | updates. LT at the engineer level provides insights |
| | | | into the |
| | | | efficiency and speed of an engineer's workflow and |
| | | | responsiveness to change requests. A shorter LT |
| | | | indicates faster turnaround time in addressing and |
| | | | completing change requests, showcasing the |
| | | | engineer's agility and effectiveness in delivering |
| | | | software changes. |
| Mean Time To | Negative | Repository: Github, Gitlab, Bitbucket, Azure | Mean Time to Recovery (MTTR) refers to the |
| Recovery | | Ci/CD: Azure Devops, Gihub Actions, Gitlab | average duration it takes for an individual |
| | | Cl/CD, Bitbucket Pipelines | engineer to recover from incidents or issues. It |
| | | | measures the time |
| | | | elapsed between the detection or occurrence of an |
| | | | incident and the successful resolution or recovery |
| | | | by the engineer. MTTR at the engineer level |
| | | | provides |
| | | | insights into the efficiency and effectiveness of an |
| | | | engineer's incident response and troubleshooting |
| | | | capabilities. A lower MTTR indicates quicker |
| | | | problem |
| | | | resolution and highlights the engineer's proficiency |
| | | | in addressing and resolving incidents promptly. |
| Changes Failure Rate | Negative | Repository: Github, Gitlab, Bitbucket, Azure | Change Failure Rate (CFR) is a metric that |
| | | Ci/CD: Azure Devops, Gihub Actions, Gitlab | measures the percentage of changes or |
| | | Cl/CD, Bitbucket Pipelines | deployments that result in failures or issues within |
| | | | a given time |
| | | | period. It quantifies the rate at which changes |
| | | | introduce problems or disruptions to the |
| | | | software or system. A higher CFR indicates a |
| | | | higher likelihood of |
| | | | unsuccessful or problematic deployments, |
| | | | highlighting areas that may require |
| | | | improvement in the organization's change |
| | | | management processes or software delivery |
| | | | practices. |
| Positive Impact | Positive | Repository: Github, Gitlab, Bitbucket, Azure | The Positive Impact Indicator measures the |
| | | Issue tracking: Jira, Trello, Asana, Clickup, | extent to which an engineer's contributions have |
| | | Monday, Teamwork, Github Projects, Gitlab | resulted in positive outcomes or improvements |
| | | Boards | within a |
| | | Time tracking: Time Doctor, Hubstaff, | project or team. It assesses the value and |
| | | Harvest, Google Calendar | effectiveness of an engineer's work in driving |
| | | Ci/CD: Azure Devops, Gihub Actions, Gitlab | positive changes. |
| | | Cl/CD, Bitbucket Pipelines | |
| PI Effective Time | Positive | Repository: Github, Gitlab, Bitbucket, Azure | The Positive Impact Effective Time indicator |
| | | Issue tracking: Jira, Trello, Asana, Clickup, | measures the amount of time an engineer |
| | | Monday, Teamwork, Github Projects, Gitlab | spends on tasks or activities that directly |
| | | Boards | contribute to positive |
| | | Time tracking: Time Doctor, Hubstaff, | outcomes and value creation in a project or team. It |
| | | Harvest, Google Calendar | focuses on the productive time spent on tasks that |
| | | Ci/CD: Azure Devops, Gihub Actions, Gitlab | lead to successful code merges, issue resolutions, |
| | | Cl/CD, Bitbucket Pipelines | feature implementations, performance |
| | | | enhancements, or other measurable positive |
| | | | impacts. |
| Positive Impact | Positive | Repository: Github, Gitlab, Bitbucket, Azure | The Positive Impact Division indicator measures |
| Division | | Issue tracking: Jira, Trello, Asana, Clickup, | the distribution of positive impacts achieved by an |
| | | Monday, Teamwork, Github Projects, Gitlab | engineer across different areas, including Code, |
| | | Boards | Tasks, Deploy, and Time. It provides insights into |
| | | Time tracking: Time Doctor, Hubstaff, | how an engineer's efforts contribute to positive |
| | | Harvest, Google Calendar | outcomes in these specific domains. |
| | | Ci/CD: Azure Devops, Gihub Actions, Gitlab | Code: This part of the indicator focuses on the |
| | | Cl/CD, Bitbucket Pipelines | engineer's impact on code quality and functionality, |
| | | | such as the number of successful code merges, |
| | | | code improvements, or bug fixes. |
| | | | Tasks: This part assesses the engineer's impact on |
| | | | task completion and resolution, including the |
| | | | number of tasks completed, tasks closed, or issues |
| | | | resolved. |
| | | | Deploy: This part evaluates the engineer's impact |
| | | | on deployment activities, such as successful |
| | | | deployments, production releases, or |
| | | | implementation of new features. |
| | | | Time: This part considers the engineer's impact in |
| | | | terms of time management and efficiency, such as |
| | | | meeting deadlines, minimizing delays, or optimizing |
| | | | work processes. |
| | | | By analyzing the Positive Impact Division indicator, |
| | | | you can gain a holistic view of an engineer's |
| | | | contributions across these different areas, |
| | | | identifying |
| | | | strengths, areas for improvement, and patterns of |
| | | | impact distribution. This |
| | | | information can help drive targeted efforts for skill |
| | | | development, process |
| | | | optimization, and resource allocation to maximize |
| | | | positive outcomes in software development |
| | | | projects. |
| Efficiency | Positive | Repository: Github, Gitlab, Bitbucket, Azure | The Efficiency Indicator measures the |
| | | Issue tracking: Jira, Trello, Asana, Clickup, | effectiveness and productivity of engineer's work. |
| | | Monday, Teamwork, Github Projects, Gitlab | It takes into account various factors such as the |
| | | Boards | number of tasks completed, the time taken to |
| | | Time tracking: Time Doctor, Hubstaff, | complete tasks, the code quality, and the |
| | | Harvest, Google Calendar | successful delivery of features or enhancements. |
| | | Ci/CD: Azure Devops, Gihub Actions, Gitlab | The Efficiency Indicator |
| | | Cl/CD, Bitbucket Pipelines | provides engineers with insights into their |
| | | | performance, efficiency, and ability to |
| | | | deliver high-quality work within a given timeframe. |
| | | | It serves as a valuable tool for self-assessment, |
| | | | identifying areas for improvement, and optimizing |
| | | | their workflow to achieve higher levels of efficiency |
| | | | and productivity. |
| Tasks Ratio | Negative | Issue tracking: Jira, Trello, Asana, Clickup, | Tasks ratio (late/in time) is an indicator that |
| (Late/In Time) | | Monday, Teamwork, Github Projects, Gitlab | measures the proportion of tasks completed late |
| | | Boards | versus tasks completed on time by an engineer. It |
| | | Time tracking: Time Doctor, Hubstaff, | provides insights into the engineer's ability to meet |
| | | Harvest, Google Calendar | task deadlines effectively. |
| PR Ratio | Negative | Repository: Github, Gitlab, Bitbucket, Azure | PR ratio (Rejected/Total) is an indicator that |
| (Rejected/Total) | | Time tracking: Time Doctor, Hubstaff, | measures the proportion of pull requests rejected |
| | | Harvest, Google Calendar | compared to the total number of pull requests |
| | | | created by an engineer. It provides insights into the |
| | | | engineer's success rate in having their pull |
| | | | requests accepted and merged into the codebase. |
| Jobs Ratio | Positive | Time tracking: Time Doctor, Hubstaff, | The Jobs ratio (Succeed/Failed) is an indicator |
| (Succeeded/Failed) | | Harvest, Google Calendar Ci/CD: Azure | that measures the ratio of successful |
| | | Devops, Gihub Actions, Gitlab Cl/CD, | deployments to failed deployments for an |
| | | Bitbucket Pipelines | engineer. It provides |
| | | | insights into the engineer's ability to successfully |
| | | | deploy changes or updates to a production |
| | | | environment. |
| Velocity | Negative | Issue tracking: Jira, Trello, Asana, Clickup, | Velocity is an indicator that measures the rate at |
| | | Monday, Teamwork, Github | which an engineer is completing work in terms of |
| | | Projects, Gitlab Boards | story points (SP). It provides insights into the |
| | | | productivity and efficiency of the engineer or team |
| | | | in delivering work over a specific time period. |
| | | | Velocity is calculated by summing up the story |
| | | | points associated with the tasks or user stories |
| | | | completed during the specified time period. It |
| | | | reflects the |
| | | | engineer's capacity to deliver value and can help |
| | | | with forecasting and planning future work. |
| Tech Debt | Negative | Repository: Github, Gitlab, Bitbucket, Azure | Tech Debt is an indicator that shows current weak |
| | | | points of the code that engineer/team is working on |
| | | | that needs to be refactored |
| Following Best | Positive | Repository: Github, Gitlab, Bitbucket, Azure | FBP is an indicator that shows how often an |
| Practice | | | engineer uses best practices in his work. It shows |
| | | | what part of the whole code produced following |
| | | | best practices in %. |
| Avg Server Downtime | Negative | Ci/CD: Azure Devops, Gihub Actions, Gitlab | Average Server Downtime is an indicator that |
| | | Cl/CD, Bitbucket Pipelines | measures the average amount of time that a server |
| | | | is not accessible. |
| Outdated | Negative | Repository: Github, Gitlab, Bitbucket, Azure | Outdated Dependencies is an indicator that |
| Dependencies | | | measures the number of software dependencies |
| | | | that are not up-to-date with their latest versions. |
| Average Server Load | Negative | Infrastructure: AWS | Average Server Load is an indicator that measures |
| | | | the average demand on a server's resources (CPU |
| | | | usage, memory) over a specific period of time. |
| Average Database | Negative | Infrastructure: AWS | Average Database Load is an indicator that |
| Load | | | measures the average demand on a database's |
| (Requests/Minute) | | | resources (requests per minute). |
| Bugs Detected | Negative | Repository: Github, Gitlab, Bitbucket, Azure | Bugs Detected (BD) is a metric that measures the |
| | | Issue tracking: Jira, Trello, Asana, Clickup, | number of bugs detected by the same engineer. |
| | | Monday, Teamwork, Github Projects, Gitlab | |
| | | Boards | |
| | | Time tracking: Time Doctor, Hubstaff, | |
| | | Harvest, Google Calendar | |
| Bugs Resolved | Positive | Repository: Github, Gitlab, Bitbucket, Azure | Bugs resolved (BR) is a metric that measures the |
| | | Issue tracking: Jira, Trello, Asana, Clickup, | number of bugs fixed by one engineer, even if they |
| | | Monday, Teamwork, Github Projects, Gitlab | were not created by him/her. |
| | | Boards | |
| | | Time tracking: Time Doctor, Hubstaff, | |
| | | Harvest, Google Calendar | |
| Bug Cycle Time: | Negative | Repository: Github, Gitlab, Bitbucket, Azure | Bug Detected Time is a metric that measures an |
| Detected | | Issue tracking: Jira, Trello, Asana, Clickup, | average time it takes to detect a bug by an |
| | | Monday, Teamwork, Github Projects, Gitlab | individual engineer. |
| | | Boards | |
| | | Time tracking: Time Doctor, Hubstaff, | |
| | | Harvest, Google Calendar | |
| Bug Cycle Time: Fixed | Negative | Repository: Github, Gitlab, Bitbucket, Azure | Bug Fixed Time is a metric that measures an |
| | | Issue tracking: Jira, Trello, Asana, Clickup, | average time it takes to fix the bug by an engineer, |
| | | Monday, Teamwork, Github Projects, Gitlab | starting from detecting this bug. |
| | | Boards | |
| | | Time tracking: Time Doctor, Hubstaff, | |
| | | Harvest, Google Calendar | |
| Bug Cycle Time: | Negative | Repository: Github, Gitlab, Bitbucket, Azure | Bug Tested Time is a metric that measures an |
| Tested | | Issue tracking: Jira, Trello, Asana, Clickup, | average time it takes to test fixed bug by an |
| | | Monday, Teamwork, Github Projects, Gitlab | individual engineer. |
| | | Boards | |
| | | Time tracking: Time Doctor, Hubstaff, | |
| | | Harvest, Google Calendar | |
| Bug Cycle Time: | Negative | Repository: Github, Gitlab, Bitbucket, Azure | Bug Closed Time is a metric that measures an |
| Closed | | Issue tracking: Jira, Trello, Asana, Clickup, | average time it takes to detect, fix, test and close a |
| | | Monday, Teamwork, Github Projects, Gitlab | bug by an individual engineer. |
| | | Boards | |
| | | Time tracking: Time Doctor, Hubstaff, | |
| | | Harvest, Google Calendar | |
| Tasks Late | Negative | Issue tracking: Jira, Trello, Asana, Clickup, | Tasks Late (TL) is a metric that measures the |
| | | Monday, Teamwork, Github Projects, Gitlab | number tasks completed later than estimated |
| | | Boards | deadline by an individual engineer. |
| | | Time tracking: Time Doctor, Hubstaff, | |
| | | Harvest, Google Calendar | |
| Tasks In Time | Positive | Issue tracking: Jira, Trello, Asana, Clickup, | Tasks In Time (TIT) is a metric that measures the |
| | | Monday, Teamwork, Github Projects, Gitlab | number of tasks completed earlier than estimated |
| | | Boards | deadline by an individual engineer. |
| | | Time tracking: Time Doctor, Hubstaff, | |
| | | Harvest, Google Calendar | |
| PRs Commented | Positive | Repository: Github, Gitlab, Bitbucket, Azure | The PR Commented Indicator refers to the count |
| | | | or number of pull requests on which an |
| | | | individual has provided comments. It represents |
| | | | the level of |
| | | | engagement and involvement of the person in |
| | | | reviewing and offering feedback |
| | | | on pull requests. Higher values indicate active |
| | | | involvement and a willingness to |
| | | | provide valuable feedback and insights to improve |
| | | | the quality of the codebase. |
| | | | It also signifies the individual's contribution to |
| | | | promoting best practices, identifying issues or |
| | | | bugs, and sharing knowledge with the team. |
| Tasks Commented | Positive | Issue tracking: Jira, Trello, Asana, Clickup, | The Tasks Commented Indicator measures the |
| | | Monday, Teamwork, Github | level of engagement an engineer has in providing |
| | | Projects, Gitlab Boards | comments on tasks within a project or workflow |
| | | | management system. It tracks the number of tasks |
| | | | on which the engineer has |
| | | | left comments, indicating their involvement in |
| | | | discussing, providing feedback, or seeking |
| | | | clarification on specific tasks. |
| Time To Reply (task) | Negative | Issue tracking: Jira, Trello, Asana, Clickup, | The Time To Reply (Task) Indicator measures the |
| | | Monday, Teamwork, Github | average time taken by an engineer to respond |
| | | Projects, Gitlab Boards | or provide a reply to a task. It helps assess the |
| | | | responsiveness and efficiency of an engineer in |
| | | | addressing tasks assigned to them. |
| Time To Reply (PRs) | Negative | Repository: Github, Gitlab, Bitbucket, Azure | The Time To Reply (PR) Indicator measures the |
| | | | duration it takes for an engineer to respond to a |
| | | | pull request. It represents the time elapsed |
| | | | between the moment a pull request is created or |
| | | | submitted for review and the moment the engineer |
| | | | provides a response or comment on the pull |
| | | | request. |
| Reaction Time (task) | Negative | Issue tracking: Jira, Trello, Asana, Clickup, | The Reaction Time (Task) indicator measures the |
| | | Monday, Teamwork, Github | average time it takes for an engineer to react or |
| | | Projects, Gitlab Boards | take initial action upon receiving a task or request. |
| | | | It provides insights into the promptness and agility |
| | | | of an engineer in acknowledging and initiating work |
| | | | on assigned tasks. |
| Reaction Time (PRs) | Negative | Repository: Github, Gitlab, Bitbucket, Azure | The Reaction Time (PR) Indicator measures the |
| | | | time it takes for an engineer to react or respond |
| | | | to a pull request. It represents the duration |
| | | | between the |
| | | | moment a pull request is created or submitted for |
| | | | review and the moment the |
| | | | engineer takes some action in response to the pull |
| | | | request, such as leaving a comment, approving the |
| | | | pull request, or making changes to the code. |
| Involvement | Positive | Repository: Github, Gitlab, Bitbucket, Azure | The Involvement Indicator measures the level of |
| | | Issue tracking: Jira, Trello, Asana, Clickup, | an engineer's active participation and engagement |
| | | Monday, Teamwork, Github Projects, Gitlab | in a project or team. It reflects the extent to which |
| | | Boards | the engineer is involved in various activities, such |
| | | Time tracking: Time Doctor, Hubstaff, | as code reviews, discussions, task assignments, |
| | | Harvest, Google Calendar | and overall collaboration within the development |
| | | Ci/CD: Azure Devops, Gihub Actions, Gitlab | process. |
| | | Cl/CD, Bitbucket Pipelines | The indicator takes into account different aspects |
| | | | of involvement, including the number of pull |
| | | | requests commented on, tasks assigned or |
| | | | worked on, code |
| | | | contributions made, participation in discussions or |
| | | | meetings, and engagement with team members. |
| Influence | Positive | Repository: Github, Gitlab, Bitbucket, Azure | The Influence Indicator refers to an engineer's |
| | | Issue tracking: Jira, Trello, Asana, Clickup, | ability to have an impact on the decisions, |
| | | Monday, Teamwork, Github Projects, Gitlab | outcomes, and direction of a project or team. It |
| | | Boards | assesses the extent to which an engineer's work |
| | | Time tracking: Time Doctor, Hubstaff, | and contributions influence and shape the overall |
| | | Harvest, Google Calendar | project's success. A higher influence score |
| | | Ci/CD: Azure Devops, Gihub Actions, Gitlab | indicates a greater ability to drive positive change |
| | | Cl/CD, Bitbucket Pipelines | and make meaningful contributions. |
| Linked data | Positive | Repository: Github, Gitlab, Bitbucket, Azure | Linked data are pieces of data that are explicitly |
| | | Issue tracking: Jira, Trello, Asana, Clickup, | associated with specific commits, PRs, tasks, |
| | | Monday, Teamwork, Github Projects, Gitlab | issues, or tickets, pipelines, time tracking tasks |
| | | Boards | within a |
| | | Time tracking: Time Doctor, Hubstaff, | source control management platform. They |
| | | Harvest, Google Calendar | represent changes directly related |
| | | Ci/CD: Azure Devops, Gihub Actions, Gitlab | to the work items |
| | | Cl/CD, Bitbucket Pipelines | |
| Unlinked data | Negative | Repository: Github, Gitlab, Bitbucket, Azure | Unlinked data are pieces of data that are not |
| | | Issue tracking: Jira, Trello, Asana, Clickup, | explicitly associated with specific commits, PRs, |
| | | Monday, Teamwork, Github Projects, Gitlab | tasks, issues, or tickets, pipelines, time tracking |
| | | Boards | tasks within a |
| | | Time tracking: Time Doctor, Hubstaff, | source control management platform. They |
| | | Harvest, Google Calendar | represent changes directly related to the work |
| | | Ci/CD: Azure Devops, Gihub Actions, Gitlab | items. |
| | | Cl/CD, Bitbucket Pipelines | |
| Ongoing KPIs | — | Platform database | Number of KPIs that is running for engineer or |
| | | | team |
| Finished KPIs | — | Platform database | Number of KPIs that is finished for engineer or |
| | | | team |
| Failed KPIs | Negative | Platform database | Number of KPIs that is finished with fail for |
| | | | engineer or team |
| KPI Fail Ratio | Negative | Platform database | Ratio of Failed KPIs to Finished KPIs |
| Industry Insight Mark | Positive | Repository: Github, Gitlab, Bitbucket, Azure | Industry Insight Mark (IIM) is an indicator that |
| | | Issue tracking: Jira, Trello, Asana, Clickup, | measures current industry trends for a specific |
| | | Monday, Teamwork, Github Projects, Gitlab | indicator and shows how an engineer, team, or |
| | | Boards | organization performs compared to the industry |
| | | Time tracking: Time Doctor, Hubstaff, | indicator. |
| | | Harvest, Google Calendar | |
| | | Ci/CD: Azure Devops, Gihub Actions, Gitlab | |
| | | Cl/CD, Bitbucket Pipelines | |
| Average Feedback | Positive | Platform database | The Feedback Score of Engineer refers to the |
| Score | | | average rating or score they receive from team |
| | | | members as feedback. It takes into account the |
| | | | multiple |
| | | | feedback submissions received from different team |
| | | | members. To calculate the |
| | | | average feedback score, a simple approach could |
| | | | be to assign equal weight to each team |
| | | | member's feedback. However, for a more |
| | | | nuanced analysis, |
| | | | weighted average feedback scores can be |
| | | | calculated based on factors such as the team |
| | | | member's role, experience, or expertise. These |
| | | | weights can be |
| | | | determined statistically by analyzing the correlation |
| | | | between a team member's feedback and the |
| | | | overall performance of the engineer, or by using |
| | | | predefined |
| | | | rules that assign higher weights to feedback from |
| | | | senior or specialized team members. The |
| | | | weighted average feedback score provides a |
| | | | more |
| | | | comprehensive evaluation, considering the varying |
| | | | contributions and |
| | | | perspectives of team members in assessing an |
| | | | engineer's performance. Average Feedback Score |
| | | | (E) refers to the average rating or score received |
| | | | for a specific question across all engineers. It |
| | | | represents the collective evaluation of that |
| | | | particular question's feedback across the entire |
| | | | group of engineers. |
| | | | Average Feedback Score (QE) is the average |
| | | | value of the Average Feedback |
| | | | Scores (E) across all questions. It provides an |
| | | | overall assessment by considering the average |
| | | | scores of each question across all engineers, |
| | | | offering a comprehensive measure of the feedback |
| | | | received from the entire group. |
| Budget Spent | Negative | Repository: Github, Gitlab, Bitbucket, Azure | Budget Spent Indicator measures the amount of |
| | | Issue tracking: Jira, Trello, Asana, Clickup, | funds spent on team, infrastructure and other |
| | | Monday, Teamwork, Github Projects, Gitlab | operational costs related to realization of a project. |
| | | Boards | |
| | | Time tracking: Time Doctor, Hubstaff, | |
| | | Harvest, Google Calendar | |
| Engineers Involved | — | Repository: Github, Gitlab, Bitbucket, Azure | Engineers Involved is a metric that shows the |
| | | Issue tracking: Jira, Trello, Asana, Clickup, | number of software engineers involved in a team or |
| | | Monday, Teamwork, Github Projects, Gitlab | organization. |
| | | Boards | |
| Profitability | Positive | Repository: Github, Gitlab, Bitbucket, Azure | Profitability is an indicator that measures the |
| | | Issue tracking: Jira, Trello, Asana, Clickup, | degree to which a team or organization generates |
| | | Monday, Teamwork, Github Projects, Gitlab | profit from their expenditures. |
| | | Boards | |
| | | Time tracking: Time Doctor, Hubstaff, | |
| | | Harvest, Google Calendar | |
| | | Ci/CD: Azure Devops, Gihub Actions, Gitlab | |
| | | Cl/CD, Bitbucket Pipelines | |
| Infrastructure Cost | Negative | Infrastructure: AWS | Infrastructure Cost is a metric used to measure the |
| | | | costs associated with maintaining the technical |
| | | | infrastructure such as servers, databases, |
| | | | software. |
| Budget Spent On Type | — | Repository: Github, Gitlab, Bitbucket, Azure | Budget Spent On Type Of Work is an indicator that |
| Of Work | | Issue tracking: Jira, Trello, Asana, Clickup, | shows how funds have been used across different |
| | | Monday, Teamwork, Github Projects, Gitlab | categories of tasks (planned, unplanned, bugs, |
| | | Boards | refactor). |
| | | Time tracking: Time Doctor, Hubstaff, | |
| | | Harvest, Google Calendar | |
| | | Ci/CD: Azure Devops, Gihub Actions, Gitlab | |
| | | Cl/CD, Bitbucket Pipelines | |
| Total Time Spent | Negative | Repository: Github, Gitlab, Bitbucket, Azure | Total Time Spent is a metric that measures total |
| | | Issue tracking: Jira, Trello, Asana, Clickup, | time spent on all tasks by team or organization. |
| | | Monday, Teamwork, Github Projects, Gitlab | |
| | | Boards | |
| | | Time tracking: Time Doctor, Hubstaff, | |
| | | Harvest, Google Calendar | |
| Task Progress | Positive | Issue tracking: Jira, Trello, Asana, Clickup, | Task Progress measures the percentage of tasks |
| | | Monday, Teamwork, Github | that have been completed at a given period of time. |
| | | Projects, Gitlab Boards | |
| Average Velocity | Negative | Repository: Github, Gitlab, Bitbucket, Azure | Average Velocity is an indicator that measures the |
| | | Issue tracking: Jira, Trello, Asana, Clickup, | average rate at which an engineer is completing |
| | | Monday, Teamwork, Github Projects, Gitlab | work in terms of story points (SP). It provides |
| | | Boards | insights into the productivity and efficiency of the |
| | | | engineer or team in delivering work over a specific |
| | | | time period. |
| Average Sprint Length | — | Issue tracking: Jira, Trello, Asana, Clickup, | Average Sprint Length is the metric that measures |
| | | Monday, Teamwork, Github | the average time spent on sprints for a given period |
| | | Projects, Gitlab Boards | of time. |
| Successful Sprints | Positive | Issue tracking: Jira, Trello, Asana, Clickup, | Successful Sprints Indicator measures the number |
| | | Monday, Teamwork, Github | of development sprints that the team completed |
| | | Projects, Gitlab Boards | fully according to the goals set. |
| Total Sprints | — | Issue tracking: Jira, Trello, Asana, Clickup, | Total Sprints Indicator measures the total number |
| | | Monday, Teamwork, Github | of development sprints over a specific period of |
| | | Projects, Gitlab Boards | time. |
| Active Engineers | — | Repository: Github, Gitlab, Bitbucket, Azure | Active Engineers is the number of engineers |
| | | Issue tracking: Jira, Trello, Asana, Clickup, | currently working in a team or organization. |
| | | Monday, Teamwork, Github Projects, Gitlab | |
| | | Boards | |
| | | Time tracking: Time Doctor, Hubstaff, | |
| | | Harvest, Google Calendar | |
| Tasks Planned | — | Issue tracking: Jira, Trello, Asana, Clickup, | Tasks Planned Indicator measures the number of |
| | | Monday, Teamwork, Github | tasks that have been scheduled for a given period |
| | | Projects, Gitlab Boards | of time. |

A listing of specific metrics and their definitions is provided below.

Meeting Break Time: Meeting break time is a metric that measures time spent on other activities between the meetings by an individual engineer. To calculate this metric we should define the time spent on the meeting per one day and the time when the engineer finished his working day.

Positive Impact: The Positive Impact Indicator measures the extent to which an engineer's contributions have resulted in positive outcomes or improvements within a project or team. It assesses the value and effectiveness of an engineer's work in driving positive changes.

Positive Impact Effective Time: The Positive Impact Effective Time indicator measures the amount of time an engineer spends on tasks or activities that directly contribute to positive outcomes and value creation in a project or team. It focuses on the productive time spent on tasks that lead to successful code merges, issue resolutions, feature implementations, performance enhancements, or other measurable positive impacts.

Positive Impact Division: The Positive Impact Division indicator measures the distribution of positive impacts achieved by an engineer across different areas, including Code, Tasks, Deploy, and Time. It provides insights into how an engineer's efforts contribute to positive outcomes in these specific domains.

Code: This part of the indicator focuses on the engineer's impact on code quality and functionality, such as the number of successful code merges, code improvements, or bug fixes.

Tasks: This part assesses the engineer's impact on task completion and resolution, including the number of tasks completed, tasks closed, or issues resolved.

Deploy: This part evaluates the engineer's impact on deployment activities, such as successful deployments, production releases, or implementation of new features.

Time: This part considers the engineer's impact in terms of time management and efficiency, such as meeting deadlines, minimizing delays, or optimizing work processes.

By analyzing the Positive Impact Division indicator, you can gain a holistic view of an engineer's contributions across these different areas, identifying strengths, areas for improvement, and patterns of impact distribution. This information can help drive targeted efforts for skill development, process optimization, and resource allocation to maximize positive outcomes in software development projects.

Efficiency: The Efficiency Indicator measures the effectiveness and productivity of engineer's work. It takes into account various factors such as the number of tasks completed, the time taken to complete tasks, the code quality, and the successful delivery of features or enhancements. The Efficiency Indicator provides engineers with insights into their performance, efficiency, and ability to deliver high-quality work within a given timeframe. It serves as a valuable tool for self-assessment, identifying areas for improvement, and optimizing their workflow to achieve higher levels of efficiency and productivity.

Reaction Time (Task): The Reaction Time (Task) indicator measures the average time it takes for an engineer to react or take initial action upon receiving a task or request. It provides insights into the promptness and agility of an engineer in acknowledging and initiating work on assigned tasks.

Reaction Time (PR): The Reaction Time (PR) Indicator measures the time it takes for an engineer to react or respond to a pull request. It represents the duration between the moment a pull request is created or submitted for review and the moment the engineer takes some action in response to the pull request, such as leaving a comment, approving the pull request, or making changes to the code.

Involvement: The Involvement Indicator measures the level of an engineer's active participation and engagement in a project or team. It reflects the extent to which the engineer is involved in various activities, such as code reviews, discussions, task assignments, and overall collaboration within the development process. The indicator takes into account different aspects of involvement, including the number of pull requests commented on, tasks assigned or worked on, code contributions made, participation in discussions or meetings, and engagement with team members.

Influence: The Influence Indicator refers to an engineer's ability to have an impact on the decisions, outcomes, and direction of a project or team. It assesses the extent to which an engineer's work and contributions influence and shape the overall project's success. A higher influence score indicates a greater ability to drive positive change and make meaningful contributions.

Linked Data: Linked Data are data that are explicitly associated with specific commits, PRs (pull requests), tasks, issues, or tickets, pipelines, time tracking tasks within a source control management platform. They represent changes directly related to the work items.

Unlinked Data: Unlinked data are data that are not explicitly associated with specific commits, PRs (pull requests), tasks, issues, or tickets, pipelines, time tracking tasks within a source control management platform. They represent changes directly related to the work items.

Feedback Score: The Feedback Score of Engineer refers to the average rating or score they receive from team members as feedback. It takes into account the multiple feedback submissions received from different team members. To calculate the average feedback score, a simple approach could be to assign equal weight to each team member's feedback. However, for a more nuanced analysis, weighted average feedback scores can be calculated based on factors such as the team member's role, experience, or expertise. These weights can be determined statistically by analyzing the correlation between a team member's feedback and the overall performance of the engineer, or by using predefined rules that assign higher weights to feedback from senior or specialized team members. The weighted average feedback score provides a more comprehensive evaluation, considering the varying contributions and perspectives of team members in assessing an engineer's performance.

Average Feedback Score (E) refers to the average rating or score received for a specific question across all engineers. It represents the collective evaluation of that particular question's feedback across the entire group of engineers.

Average Feedback Score (QE) is the average value of the Average Feedback Scores (E) across all questions. It provides an overall assessment by considering the average scores of each question across all engineers, offering a comprehensive measure of the feedback received from the entire group.

Industry Insight Mark: Industry Insight Mark (IIM) is an indicator that measures current industry trends for a specific indicator and shows how an engineer, team, or organization performs compared to the industry indicator.

### Operational Description

Methods utilizing Large Language Models (LLMs) in software challenges are presented. A first method focuses on a competitive format between two participants. A user proposes and another user accepts a competition, after which a tailored software challenge, based on their profiles, is created by an LLM. After submission, another LLM evaluates their solutions against the challenge's criteria to determine a winner. A second method revolves around crafting personalized software challenges using LLMs. These challenges are based on various factors, like software ticket details or user characteristics. Accompanied by specific requirements, the challenge is communicated to the user. Upon completion, the solution is assessed for compliance with the set requirements, and successful participants receive an award. Both methods highlight the LLM's capability in automating and personalizing software challenges.

A first method for organizing a software development competition between two participants is disclosed. Initially, one user proposes the competition and another user joins by sending their respective requests. Based on characteristics or profiles of both participants, a unique software development challenge is crafted. This challenge is not just a task but comes with specific requirements or criteria, both of which are tailored using a Large Language Model (LLM). After receiving the challenge, both users submit their code as solutions. Another, or the same, LLM then steps in to compare the two code listings and checks each solution against the set challenge requirements. Finally, the winner is determined considering three main factors: how the two code listings compare, whether the first user's code aligns with the challenge's criteria, and the same for the second user's code. In summary, this method leverages the capabilities of LLMs to automate and personalize the process of hosting software competitions.

Additionally, both participants can stake a competition ante, which goes to the winner. The entire process, from challenge creation to winner determination, can be handled by a computing system, and participants interact and receive feedback via a website interface. The evaluating LLM can be one of multiple models, including potential third models not used in challenge creation.

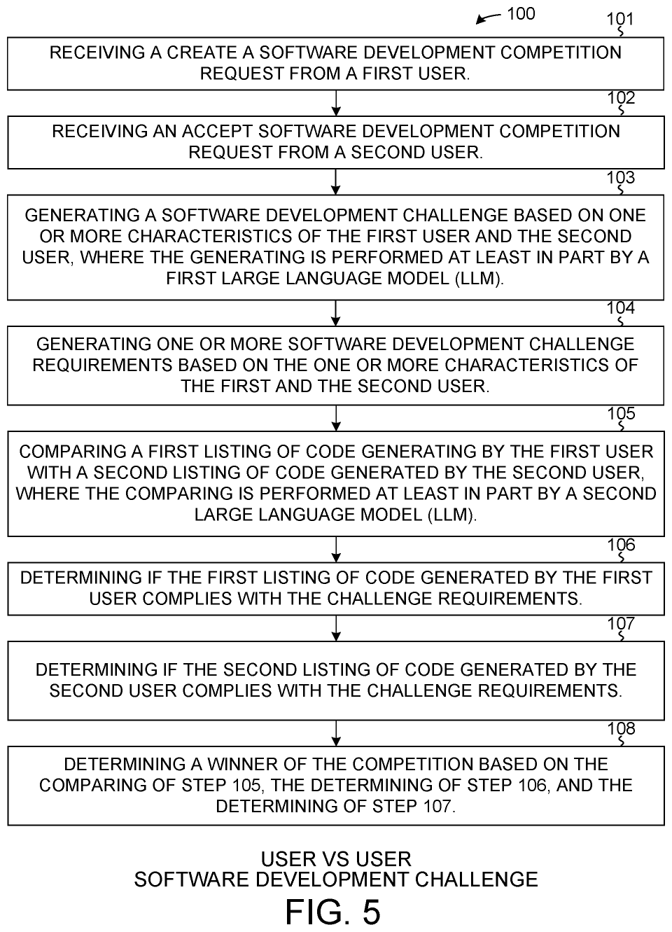

The detailed steps of this first method for organizing a software development competition between two participants are illustrated in FIG. 5. In step 101, a create a software development competition request is received from a first user. In step 102, an accept software development competition request is received from a second user. In step 103, a software development challenge is generated based on one or more characteristics of the first user and the second user, wherein the generating of step 103 is performed at least in part by a first Large Language Model (LLM). In step 104, one or more software development challenge requirements are generated based on the one or more characteristics of the first and the second user. In step 105, a first listing of code generated by the first user is compared with a second listing of code generated by the second user. The comparing of step 105 is performed at least in part by a second Large Language Model (LLM). In step 106, it is determined if the first listing of code generated by the first user complies with the challenge requirements. In step 107, it is determined if the second listing of code generated by the second user complies with the software development challenge requirements. In step 108, it is determined if a winner of the competition is based on the comparing of step 105, determining of step 106, and determining of step 107.

A second method for crafting and overseeing a software development challenge, drawing upon the capabilities of Large Language Models (LLM) is disclosed. The foundation of the challenge can be based on a variety of factors, such as the name or description of a software ticket or specific characteristics of the participating user. Aided by the first LLM, this challenge is meticulously formulated. Beyond the primary challenge, there are accompanying requirements tailored to the user, designed with the assistance of a second LLM. Once ready, the user receives a comprehensive description of both the challenge and its requirements. The system actively observes and identifies when the user has finished the challenge. Subsequently, the user's submitted solution is evaluated to see if it aligns with the outlined requirements. On successful adherence and completion, the user is granted an award, acknowledging their accomplishment and compliance with the challenge's standards.

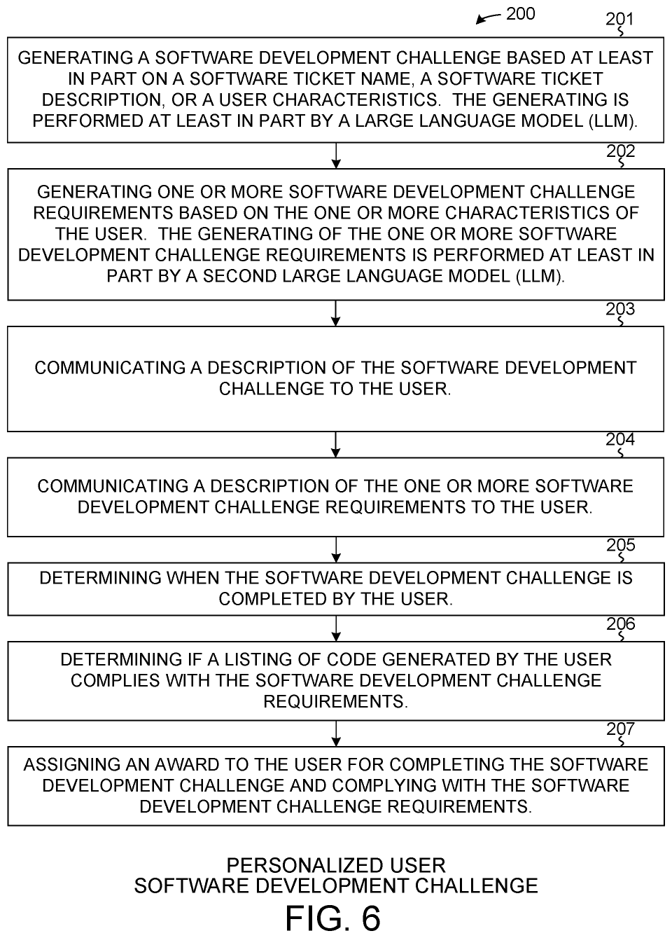

The detailed steps of this second method for crafting and overseeing a software development challenge, drawing upon the capabilities of Large Language Models (LLM) are illustrated in FIG. 6. In step 201, a software development challenge is generated based at least in part on a software ticket name, a software ticket description, or a user characteristic. The generating of step 201 is performed at least in part by a first Large Language Model (LLM). In step 202, one or more software development challenge requirements is generated based on the one or more characteristics of the user. The generating of the one or more software development challenge requirements is performed at least in part by a second, or the first, Large Language Model (LLM). In step 203, a description of the software development challenge is communicated to the user. In step 204, a description of the one or more software development challenge requirements is communicated to the user. In step 205, it is determined when the software development challenge is completed by the user. In step 206, it is determined if a listing of code generated by the user complies with the software development challenge requirements. In step 207, an award is assigned to the user for completing the software development challenge and complying with the software development challenge requirements.

### User Interface

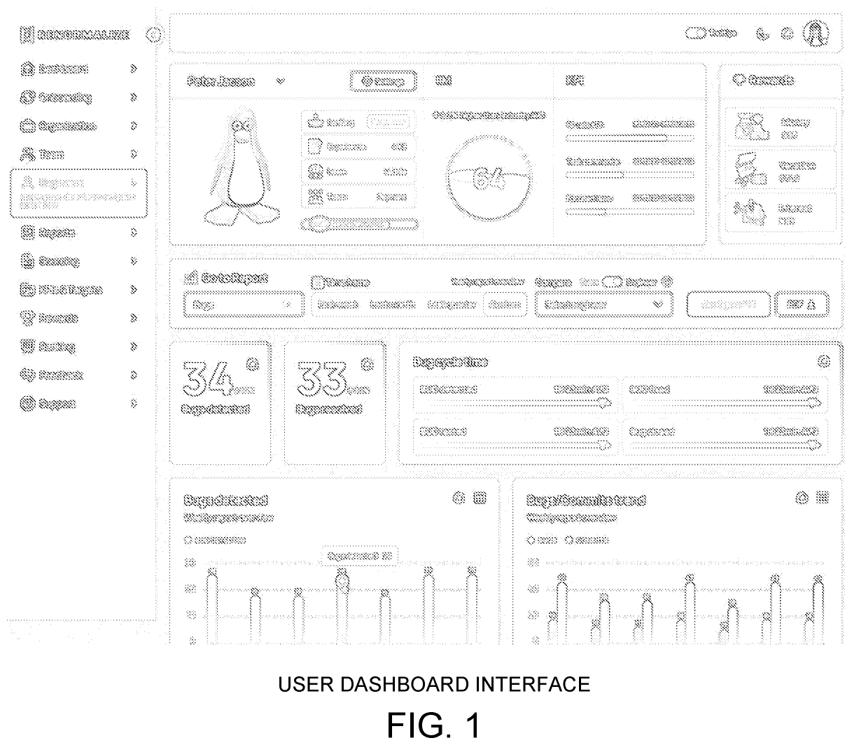

FIG. 1 is an exemplary user interface, also referred to as a “Dashboard”. In one embodiment, the user interface includes the user's name, user settings, user ranking, user experience, user level (skill), user team, user Key Performance Indicators (“KPI”), industry ranking against similar software developers, rewards (type and amounts), number of bugs detected, number of bugs resolved, bug cycle time, and number of commits over time. In one example, the user is able to adjust the time period over which the dashboard data is based upon. This dashboard may also be viewable by the user's manager to help evaluate the user's performance.

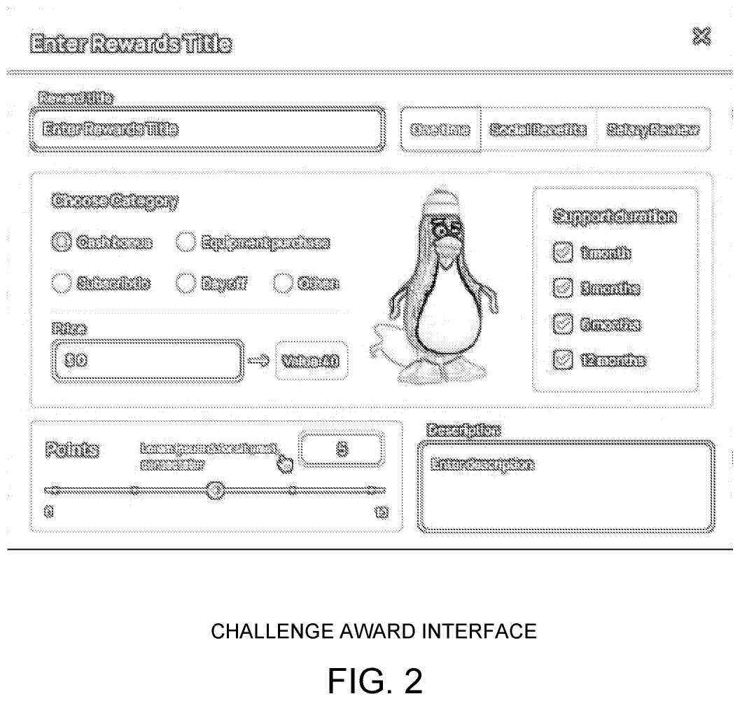

FIG. 2 is an exemplary reward entry interface, also referred to as a “Reward board”. In one embodiment, the reward entry interface includes a reward title, a reward frequency selector, a reward category type (cash bonus, equipment purchase, subscription, day off, or other manual entry), a price value (in dollars), a converted value based on the price value, a points counter, a support duration selector (different durations), and a description box for entering a written description of the reward. In this fashion, an administrator, such as a manager, can create or update a reward that a user can strive to achieve.

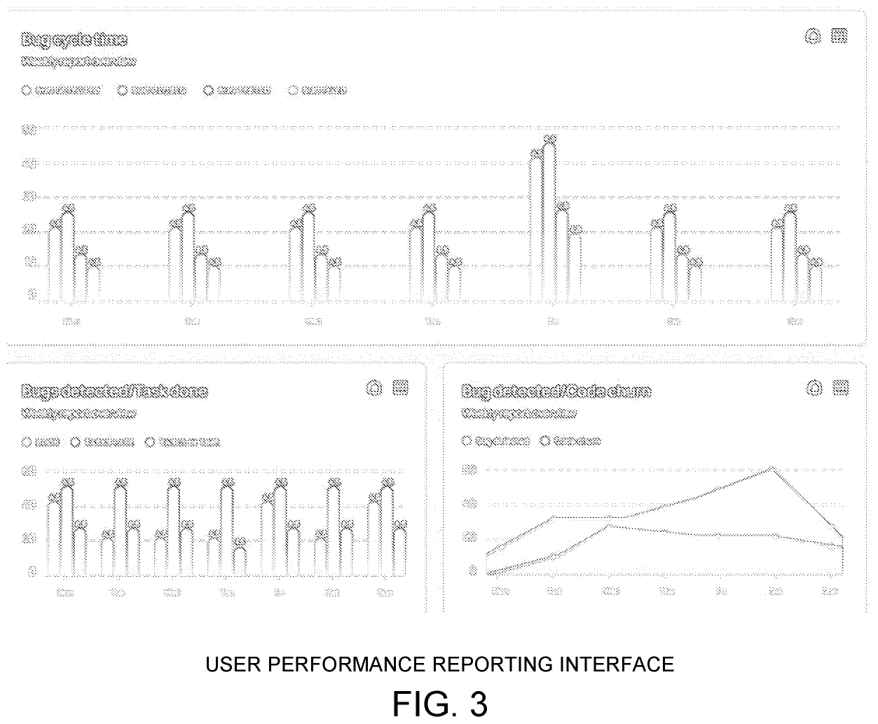

FIG. 3 is an exemplary user performance reporting interface. In one example, the user reporting interface includes a bug cycle time graph illustrating bugs detected, bugs closed, bugs tested, and bugs fixed; a bug detected/task done graph illustrating bugs, tasks late, and tasks in time; and a bug detected/code churn graph illustrating bugs detected and code chum. Each of these graphs may be plotted against time so to provide a visual representation of the user's progress over time.

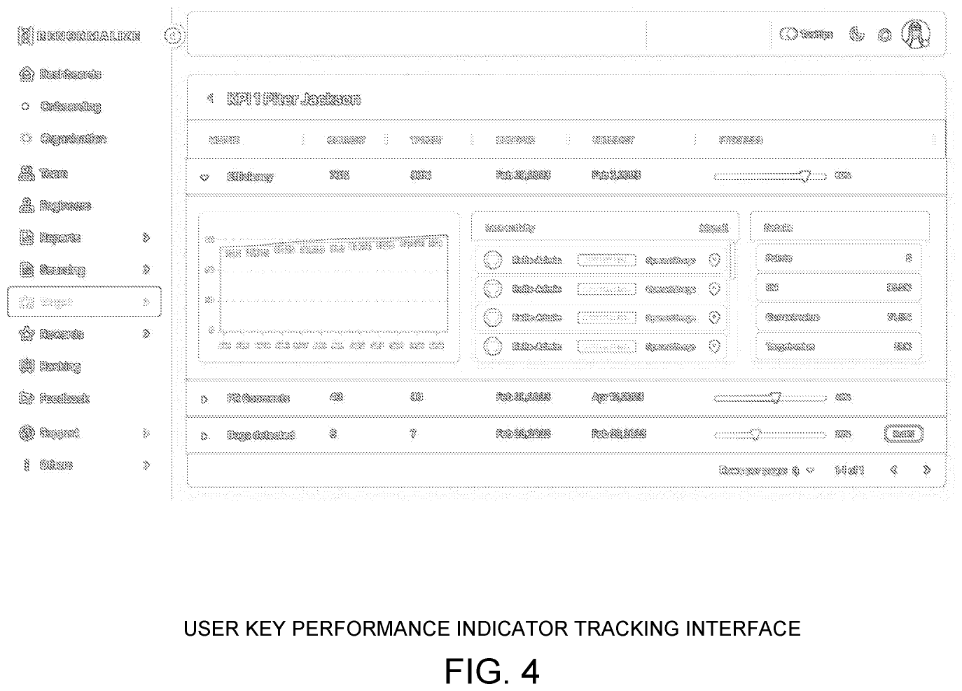

FIG. 4 is an exemplary user interface displaying a user's key performance indicators (KPI). In one example, the user interface includes the user's name, the selectable key performance indicator button, a chart of the KPI over time, recent activity of the user, details of the user, pull request comments regarding the user and bugs detected regarding the user. This user interface is useful for the user to review their performance, as well as for managers that need to evaluate the user's performance.

### Supporting Hardware

The inventive aspects and embodiments described herein can be implemented using a wide array of physical devices executing various instructions. In one example, the steps described herein are processed by one or more computing devices (e.g. servers) which work in concert to perform all required functions. Users access the system's services via a separate computing device (e.g. desktop, laptop, tablet, mobile device, etc.) and a browser application operating thereon. These devices each include one or more processors circuits, memory circuits, and data communication circuits. One skilled in the art will readily, after reading this disclosure, understand all the various hardware combinations that could be utilized to implement the inventive ideas disclosed herein.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

1. A method, comprising:
(a) receiving a create a software development competition request from a first user;
(b) receiving an accept software development competition request from a second user;
(c) generating a software development challenge based on one or more characteristics of the first user and the second user, wherein the generating of (c) is performed at least in part by a first Large Language Model (LLM);
(d) generating one or more software development challenge requirements based on the one or more characteristics of the first and the second user;
(e) comparing a first listing of code generated by the first user with a second listing of code generated by the second user, wherein the comparing of (e) is performed at least in part by a second Large Language Model (LLM);
(f) determining if the first listing of code generated by the first user complies with the challenge requirements;
(g) determining if the second listing of code generated by the second user complies with the software development challenge requirements; and
(h) determining a winner of the competition based on the comparing of (e), the determining of (f), and the determining of (g).

2. The method of claim 1, further comprising:
(a1) receiving a first competition ante from the first user; and
(b1) receiving a second competition ante from the second user, wherein the first competition ante and the second competition ante are both assigned to the winner determined in (h).

3. The method of claim 1, wherein the first user characteristic and the second user characteristic includes a user experience level, a user knowledge of programming languages, a user Key Performance Indicators (KPIs), or a user performance metrics.

4. The method of claim 1, wherein the first Large Language Model (LLM) and the second Large Language Model (LLM) are the same.

5. The method of claim 1, wherein the one or more characteristics of the first or second user is a meeting break time, a positive impact effective time indicator, a positive impact division indicator, an efficiency indicator, a task reaction time indicator, a pull request reaction time indicator, an involvement indicator, a influence indicator, a linked data, an unlinked data, a feedback score, or an industry insight mark indicator.

6. The method of claim 1, wherein the one or more characteristics of the first or second user is a focused time, a poor time indicator, a working days indicator, a hours overtime indicator, a code churn indicator, a coding days indicator, a time usage by app indicator, a commits indicator, a pull requests merged indicator, a pull requests reviewed indicator, a large pull requests indicator, an inactive pull requests indicator, a cycled pull requests indicator, an overcommented pull requests indicator, an average pull request open time indicator, a pull request review time indicator, a pull request merged time indicator, a pull request closed time indicator, a task done indicator, a deployment frequency indicator, a lead time for changes indicator, a mean time to recovery indicator, a change failure rate indicator, a bugs closed indicator, a positive impact indicator, a task ratio indicator, a pull request ratio indicator, a jobs ratio indicator, a velocity indicator, a task late indicator, a task in time indicator, an epic indicator, a lead time indicator, a bugs detected indicator, a bugs resolved indicator, a bug cycle time indicator, a bug detected time indicator, a bug fix time indicator, a bug tested time indicator a bug closed time indicator, a pull request commented indicator, a task commented indicator, a time to reply indicator, a time to reply to pull request indicator, an industry insight mark indicator, a tech debt indicator, a following best practices indicator, an average server downtime indicator, an outdates dependencies indicator, an average server load indicator, an average database load indicator, a budget spent indicator, and engineers involved indicator, a profitability indicator, an infrastructure cost indicator, a budget spend on type of work indicator, a total time spent indicator, a task progress indicator, an average velocity indicator, an average sprint length indicator, a successful sprint indicator, a total sprints indicator, an active engineers indicator, or a tasks planned indicator.

7. The method of claim 1, wherein steps (a) through (h) are performed by a computing system comprising:
one or more processor circuits; and
a non-transitory computer readable medium storing a program, the program instructing the one or more processor circuits to perform the steps (a) through (h).

8. The method of claim 1, wherein the software development challenge and the one or more software development challenge requirements are communicated to the first user and the second user via a website interface, and wherein the method further comprises proving real-time feedback to the first user or second user during the software development challenge.

9. The method of claim 1, wherein the results of (e) through (h) are displayed to the first user and the second user via a website interface, and wherein the results include a pass or fail indicator, an analysis of issues, a comparison of the degree to which each user met the software development challenge requirements, an example of improvements, and a comparison between the first user and second user.

10. The method of claim 1, wherein the determining of (f), (g) and (h) are performed by the first LLM, the second LLM, or a third LLM.

11. A method, comprising:
(a) generating a software development challenge based at least in part on a software ticket name, a software ticket description, or a user characteristic, wherein the generating of (a) is performed at least in part by a first Large Language Model (LLM);
(b) generating one or more software development challenge requirements based on the one or more characteristics of the user, wherein the generating of the one or more software development challenge requirements is performed at least in part by a second Large Language Model (LLM);
(c) communicating a description of the software development challenge to the user;
(d) communicating a description of the one or more software development challenge requirements to the user;
(e) determining when the software development challenge is completed by the user;
(f) determining if a listing of code generated by the user complies with the software development challenge requirements; and
(g) assigning an award to the user for completing the software development challenge and complying with the software development challenge requirements.

12. The method of claim 11, wherein the user characteristic includes a user experience level, a user knowledge of programming languages, a user Key Performance Indicators (KPIs), or a user performance metrics.

13. The method of claim 11, wherein the first Large Language Model (LLM) and the second Large Language Model (LLM) are the same.

14. The method of claim 11, wherein the award is based at least in part on the user's Key Performance Indicators (KPIs) or user's performance metrics.

15. The method of claim 11, wherein the one or more characteristics of the user is a meeting break time, a positive impact effective time indicator, a positive impact division indicator, an efficiency indicator, a task reaction time indicator, a pull request reaction time indicator, an involvement indicator, a influence indicator, a linked data, an unlinked data, a feedback score, or an industry insight mark indicator.

16. The method of claim 11, wherein the one or more characteristics of the user is a focused time, a poor time indicator, a working days indicator, a hours overtime indicator, a code churn indicator, a coding days indicator, a time usage by app indicator, a commits indicator, a pull requests merged indicator, a pull requests reviewed indicator, a large pull requests indicator, an inactive pull requests indicator, a cycled pull requests indicator, an overcommented pull requests indicator, an average pull request open time indicator, a pull request review time indicator, a pull request merged time indicator, a pull request closed time indicator, a task done indicator, a deployment frequency indicator, a lead time for changes indicator, a mean time to recovery indicator, a change failure rate indicator, a bugs closed indicator, a positive impact indicator, a task ratio indicator, a pull request ratio indicator, a jobs ratio indicator, a velocity indicator, a task late indicator, a task in time indicator, an epic indicator, a lead time indicator, a bugs detected indicator, a bugs resolved indicator, a bug cycle time indicator, a bug detected time indicator, a bug fix time indicator, a bug tested time indicator a bug closed time indicator, a pull request commented indicator, a task commented indicator, a time to reply indicator, a time to reply to pull request indicator, an industry insight mark indicator, a tech debt indicator, a following best practices indicator, an average server downtime indicator, an outdates dependencies indicator, an average server load indicator, an average database load indicator, a budget spent indicator, and engineers involved indicator, a profitability indicator, an infrastructure cost indicator, a budget spend on type of work indicator, a total time spent indicator, a task progress indicator, an average velocity indicator, an average sprint length indicator, a successful sprint indicator, a total sprints indicator, an active engineers indicator, or a tasks planned indicator.

17. The method of claim 11, wherein steps (a) through (g) are performed by a system comprising:
one or more processor circuits; and
a non-transitory computer readable medium storing a program, the program instructing the one or more processor circuits to perform the steps (a) through (g).

18. The method of claim 11, wherein the software development challenge and the one or more software development challenge requirements are communicated to the user via a website interface, wherein one of the software development challenge requirements is an amount of time allotted to complete the software development challenge, a user's metric performance improvement related to a metric, and a comparison of the degree to which each user met the software development challenge requirements.

19. The method of claim 11, wherein the results of (f) and (g) are displayed to the user via a website interface.

20. The method of claim 11, wherein the determining of (e) and (f) are performed by the first LLM, the second LLM, or a third LLM.

21-40. (canceled)
